(19) United States
(12) Patent Application Publication
(10) Pub. No.: US 2019/0035229 A1
(43) Pub. Date: Jan. 31, 2019

(54) INDEPENDENT SKILL-WAGER ELEMENT WAGERING SYSTEM

(71) Applicant: Gamblit Gaming, LLC, Glendale, CA (US)

(72) Inventors: Bryce Cire, Pasadena, CA (US); Frank Cire, Pasadena, CA (US)

(21) Appl. No.: 15/968,723

(22) Filed: May 1, 2018

Related U.S. Application Data
(60) Provisional application No. 62/492,880, filed on May 1, 2017.

(51) Int. Cl. G07F 17/32; G06F 7/58; G06Q 50/34

(52) U.S. Cl. CPC G07F 17/3295; G07F 17/3262; G06Q 50/34; G06F 7/582; G07F 17/3223

(57) ABSTRACT

An independent skill-wager element wagering system is disclosed. The system includes an interactive controller constructed to generate an independent skill-wager element of an interactive application, present the independent skill-wager element to a player, detect the player's interactions with the independent skill-wager element, communicate the player's interactions to a process controller, receive a random component from a process controller, determine that the player has achieved an objective associated with the interactive element on the basis of the random component. The process controller is constructed to communicate with the interactive controller, receive the player's interactions from the interactive controller, generate the random component in response to receiving the player's interactions, and communicate the random component to the interactive controller.

### CROSS REFERENCE TO RELATED APPLICATION(S)

This application claims the benefit of U.S. Provisional Patent Application No. 62/492,880, filed May 1, 2017, the contents of which are incorporated by reference herein.

### FIELD OF THE INVENTION

Embodiments of the invention are generally related to communications within data processing systems. More particularly, embodiments of the invention relate to the communication and processing of wagering data.

### BACKGROUND

The gambling industry has traditionally developed simple gambling games having simple randomized features that are implementable on conventional electronic gambling machines (EGMs). However, in order to implement a complex gambling game having complex randomized features, data processing systems capable of implementing complex randomized features are needed. Various aspects of embodiments of the invention meet such needs.

### SUMMARY OF THE INVENTION

Systems and methods in accordance with embodiments of the invention generate and process stochastic events within a context of an interactive application in order to implement an interactive wagering processes utilizing independent skill-wager elements.

In an embodiment, an independent skill-wager element wagering system includes an interactive controller constructed to generate an independent skill-wager element of an interactive application, present the independent skill-wager element to a player, detect the player's interactions with the independent skill-wager element, communicate the player's interactions to a process controller, receive a random component from a process controller, and determine that the player has achieved an objective associated with the interactive element on the basis of the random component. The process controller constructed to communicate with the interactive controller, wherein the process controller is constructed to receive the player's interactions from the interactive controller, generate the random component in response to receiving the player's interactions, and communicate the random component to the interactive controller.

In another embodiment, the interactive controller and the process controller are constructed from the same device.

In yet another embodiment, the process controller is operatively connected to the interactive controller using a communication link.

In yet another embodiment, an independent skill-wager element wagering system further includes an enclosure constructed to mount a user input device operatively connected to the interactive controller, a user output device operatively connected to the interactive controller, a credit input device operatively connected to the process controller, and a credit output device operatively connected to the process controller.

In yet another embodiment a skill-wager element wagering system further includes a random number generator, wherein the process controller is further constructed to communicate with the credit input device to receive a credit input, credit a credit meter with credits based on the incoming credit data, generate the random component using the random number generator, receive a skill-wager outcome from the interactive controller, update the credit meter based on skill-wager outcome of the wager, and communicate with the credit output device to generate a credit output based on credits transferred off of the credit meter. The interactive controller is further constructed to determine the skill-wager outcome based on the player's interactions with the independent skill-wager element and the random component, and communicate the skill-wager outcome to the process controller.

In yet another embodiment, an independent skill-wager element wagering system, includes at least one processor, and a memory coupled to the at least one processor, the memory storing processor executable instructions that when executed by the at least one processor cause the at least one processor to generate an independent skill-wager element of an interactive application, present the independent skill-wager element to a player, detect the player's interactions with the independent skill-wager element, generate the random component in response to receiving the player's interactions, and determine that the player has achieved an objective associated with the interactive element on the basis of the random component.

In yet another embodiment, an independent skill-wager element wagering system further includes an enclosure constructed to mount a user input device operatively connected to the at least one processor, a user output device operatively connected to the at least one processor, a credit input device operatively connected to the at least one processor, and a credit output device operatively connected to the at least one processor.

In yet another embodiment, an independent skill-wager element wagering system further includes a random number generator, wherein the processor-executable instructions further cause the at least one processor to communicate with the credit input device to receive a credit input, credit a credit meter with credits based on the incoming credit data, generate the random component using the random number generator, determine the skill-wager outcome based on the player's interactions with the independent skill-wager element and the random component, and update the credit meter based on skill-wager outcome of the wager.

In an embodiment of the invention, a process controller operates as an interface between an interactive controller that resolves a skill-wager outcome of a skill-wager proposition and a wagering subcontroller that determines random components. By virtue of this feature, the wagering subcontroller is isolated from the interactive controller allowing the interactive controller to operate in an unregulated environment while allowing the wagering subcontroller to operate in a regulated environment, thus providing for more efficient management of the operations of such a system.

In another embodiment of the invention, a single wagering subcontroller may provide services to two or more interactive controllers, thus allowing an independent skill-wager element wagering system to operate more efficiently over a large range of scaling.

In another embodiment of the invention, multiple types of interactive controllers using different operating systems may be interfaced to a single type of process controller without requiring customization of the process controller and/or the wagering subcontroller, thus improving the efficiency of the process controller and/or the wagering subcontroller by reducing complexity associated with maintaining separate process controllers and/or wagering subcontrollers for each type of interactive controller.

In another embodiment of the invention, an interactive controller may be provided as a player device under control of a player while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the independent skill-wager element wagering system.

In another embodiment of the invention, a process controller isolates random component logic and skill-wager proposition logic as unregulated logic from a regulated wagering subcontroller, thus allowing errors in the skill-wager proposition logic and/or random component logic to be corrected, new skill-wager proposition logic and/or random component logic to be used, or modifications to be made to the skill-wager proposition logic and/or random component logic without a need for time-consuming regulatory approval.

In another embodiment of the invention, an interactive application may require extensive processing resources from an interactive controller leaving few processing resources for the functions performed by a process controller and/or a wagering subcontroller. By virtue of an architecture of some embodiments of the invention, processing loads may be distributed across multiple devices such that operations of the interactive controller may be dedicated to an interactive application and the processes of the process controller and/or wagering subcontroller are not burdened by the requirements of the interactive application.

In another embodiment of the invention, an independent skill-wager element wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of an independent skill-wager element wagering system are distributed in close proximity to each other and communicate using a local area network and/or a communication bus. In several embodiments, an interactive controller and a process controller of an independent skill-wager element wagering system are in a common location. In some embodiments, a process controller communicates with an external interactive controller. In various embodiments, these multiple controllers and subcontrollers can be constructed from or configured using a single device or a plurality of devices such that an independent skill-wager element wagering system is executed as a system in a virtualized space such as, but not limited to, where a wagering subcontroller and a process controller are large scale centralized servers and are operatively connected to distributed interactive controllers via a wide area network such as the Internet or a local area network. In such embodiments, the components of an independent skill-wager element wagering system may communicate using a networking protocol or other type of device-to-device communications protocol.

In another embodiment of the invention, an interactive controller is an interactive server acting as a host for managing head-to-head player interactions over a network of interactive subcontrollers connected to the interactive server using a communication link. The interactive server provides an environment where players can compete directly with one another and interact with other players.

### BRIEF DESCRIPTION OF THE DRAWINGS

FIG. 1 is a diagram of a structure of an independent skill-wager element wagering system in accordance with various embodiments of the invention.

FIG. 2A is a diagram of an electronic gaming machine configuration of an independent skill-wager element wagering system in accordance with various embodiments of the invention.

FIG. 2B is a diagram of a table electronic gaming machine configuration of an independent skill-wager element wagering system in accordance with various embodiments of the invention.

FIG. 2C is a diagram of a virtual reality gaming machine configuration of an independent skill-wager element wagering system in accordance with various embodiments of the invention.

FIG. 3 is a diagram of distributed independent skill-wager element wagering systems in accordance with various embodiments of the invention.

FIGS. 4A and 4B are diagrams of a structure of an interactive controller of an independent skill-wager element wagering system in accordance with various embodiments of the invention.

FIG. 5 is a diagram of a structure of a process controller of an independent skill-wager element wagering system in accordance with various embodiments of the invention.

FIG. 6 is a diagram of a structure of a credit processing controller of an independent skill-wager element wagering system in accordance with various embodiments of the invention.

FIG. 7 is an illustration of a user interface of an independent skill-wager element wagering system in accordance with various embodiments of the invention.

FIG. 8 is a block diagram of a process of an independent skill-wager element wagering system in accordance with various embodiments of the invention.

FIG. 9 is a sequence diagram of interactions between components of an independent skill-wager element wagering system in accordance with various embodiments of the invention.

FIG. 10 is a state diagram illustrating a wagering process of an independent skill-wager element wagering system in accordance with various embodiments of the invention.

FIG. 11 is a depiction of a non-player character configuration process in accordance with various embodiments of the invention.

FIG. 12 is a flowchart of a process of an independent skill-wager element wagering system in accordance with various embodiments of the invention.

### DETAILED DESCRIPTION

An example conventional slot machine game is a mechanical 3 reel slot machine having 22 possible positions or symbols on each reel. In such a slot machine game, there are 22̂3, or 10,648, possible pays based on the combinations of the reel positions. Each time the slot machine is played, a single pay is determined from a single independent random event, namely the spinning of the mechanical reels. If such a 3 reel slot machine is implemented on a conventional electronic gaming machine having virtual video reels, each possible pay is explicitly enumerated in a paytable that is used to determine a pay as well as determine an animation sequence of the video virtual reels that corresponds to the pay. The combination of a pay and an associated reel animation sequence constitute a game feature. Such a paytable will have at least 10,648 locations, one position for each possible combination of the 3 reels, with each location representing a pay and a representation of the stopped position of the 3 reels. If digital storage of each pay requires 8 bytes of storage, such a paytable can be stored in approximately 83 kilobytes of digital memory (8 bytes of data for each game feature×10,648 possible pays/1024 Bytes per kilobyte). In operation, a single random number is determined, and that random number is used as an index into the paytable to select a game feature of a single pay and reel animation identifier from the 10,648 possible pays and reel animations. Accordingly, approximately 83 kilobytes of memory is needed to store the enumerated game features of a simple slot machine game having approximately 10 thousand game features on a conventional electronic gaming machine.

In accordance with various embodiments, a complex wagering game can be modeled using a multidimensional game space or manifold where each dimension of the manifold is associated with a stochastic event of the complex wagering game. Such a complex wagering game will have multiple states within the game space with some of the states being intermediate states and some of the states being wager outcome states. Complex wagering games implemented using interactive wagering processes as described herein have sets of intermediate states and wager outcome states whose sizes are many orders of magnitude larger than a set of pays of a simple slot machine game. In an example embodiment, a complex wagering game incudes a display where selectable chance-based outcomes are displayed to a player as a set of possible wager outcome states. The display includes 9 locations with each location having twenty-two possible chance-based outcomes. Such a complex wagering game display has 1,207,269,217,792, or over 1.2 trillion, possible wager outcome states. If 8 bytes of digital memory are used to store each wager outcome state, then a complete enumeration of all of wager outcome states, as required using conventional electronic game machine architecture, would require 9.6 terabytes of memory storage. However, utilization of a independent skill-wager element wagering system and interactive wagering processes as described herein reduces storage memory requirements for such a complex wagering game feature to less than 1 megabyte. Such a reduction in memory requirements reduces the amount of physical and/or virtual memory needed to implement the complex wagering game, and also may reduce an amount of time needed to generate such a complex wagering game display.

In another example embodiment, a complex wagering game has a game space with 17 dimensions and approximately 1,576,418,005,371,090,000,000, or over 1.5 sextillion possible intermediate states and wager outcome states. Enumeration and storage of such a set of states for implementation of the complex wagering game on a conventional electronic gaming machine would require over 12.6 zettabytes of addressable memory storage which is simply not possible using conventional processor architecture; accordingly, such complex wagering games are simply not implementable using conventional electronic gaming machines. However, such complex wagering games may be implemented on various embodiments of a independent skill-wager element wagering system as described herein.

An independent skill-wager element wagering system allows for the management of independent skill-wager elements within a skill-based wagering game where the independent skill-wager elements have one or more random components. One or more independent skill-wager elements compose a skill-wager proposition. In some embodiments of an independent skill-wager element wagering system, an interactive application executed by an interactive controller a provides skill-wager proposition of the independent skill-wager element wagering system. The interactive controller is operatively connected to a process controller that manages and configures the interactive controller and the interactive application, and determines skill-wager propositions having random components determined by a wagering subcontroller that are resolved as skill-wager outcomes determined by the interactive application.

In some embodiments, the interactive controller also provides a wagering user interface that is used to receive commands and display data for a wagering process and wagering outcome determined from the skill-wager outcome in accordance with a skill-wager proposition. The content of the wagering user interface is controlled by the process controller and includes content provided by the wagering subcontroller and the interactive controller.

In various embodiments, an interactive controller provides a management user interface used to manage a player profile.

Many different types of interactive applications may be utilized with the independent skill-wager element wagering system. In some embodiments, the interactive application reacts to the physical activity of a player. In these embodiments, the interactive application senses player interactions with the interactive application through one or more sensors that monitor the player's physical activities. Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors.

In some embodiments, the interactive application implements a skill-based game and interacts with the player by sensing skillful interactions with an interactive user interface generated by the interactive application.

In many embodiments, the interactive application generates various types of interactive elements including independent skill-wager elements in an interactive application environment. In some embodiments, these interactive elements are interactive application resources utilized within the interactive application environment to provide an interactive experience for a player.

In accordance with some embodiments, a random component of the skill-wager proposition can influence interactive elements in the interactive application environment such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, the wagers may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the interactive application, application credits can be optionally consumed and/or accrued within the interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based interactive application. The skill-based interactive application can have one or more scoring criteria, embedded within a process controller and/or an interactive controller that provides the skill-based interactive application, that can be used to determine player performance against one or more goals of the skill-based interactive application in accordance with a skill-wager proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, a skill-wager proposition includes a wager of application credits for payout of application credits, interactive application elements, and/or interactive application objects in accordance with the chance-based proposition.

In a number of embodiments, a wager of an amount of credits results in a payout of application credits, interactive elements, and/or interactive application objects that have a credit value if cashed out.

In some embodiments, interactive application objects include in-application objects that may be utilized to enhance player interactions with the interactive application. Such objects include, but are not limited to, power-ups, enhanced in-application items, and the like. In some embodiments, the interactive application objects include objects that are detrimental to player interactions with the interactive application such as, but not limited to, obstructions in the interactive application space, a temporary handicap, an enhanced opponent, and the like.

In numerous embodiments, an interactive application command is an instruction by a process controller to an interactive controller and/or an interactive application of the interactive controller to modify a state of an interactive application or modify one or more interactive application resources or interactive elements. In some embodiments, the interactive application commands may be automatically generated by the process controller using one or more of a random component and/or application environment variables. An interactive application command can be used by a process controller control many processes of an interactive application, such as, but not limited to, an causing an addition of a period of time available for a current interactive application session for the interactive application, an addition of a period of time available for a future independent skill-wager element wagering system interactive application session or any other modification to the interactive application interactive elements that can be utilized during an interactive application session.

In some embodiments, asynchronous communications provided for by an independent skill-wager element wagering system may reduce an amount of idle waiting time by an interactive controller of the independent skill-wager element wagering system, thus increasing an amount of processing resources that the interactive controller may provide to an interactive application or other processes of the interactive controller. In many embodiments, asynchronous communications provided for by an independent skill-wager element wagering system reduces an amount of idle waiting time by a process controller, thus increasing an amount of processing resources that the process controller may provide to determine random components, and other processes provided by the process controller.

In some embodiments, a wagering subcontroller of an independent skill-wager element wagering system may be operatively connected to a plurality of interactive controllers through a process controller and the asynchronous communications provided for by the process controllers allows the wagering subcontroller to operate more efficiently by providing random components to a larger number of interactive controllers than would be achievable without the process controller of the independent skill-wager element wagering system.

In some embodiments, an independent skill-wager element wagering system including a process controller operatively connected to a wagering subcontroller and operatively connected to an interactive controller wherein the process controller provides for simplified communication protocols for communications of the interactive controller as the interactive controller may communicate interactions with an interactive application provided by the interactive controller to the process controller without regard to a nature of a chance-based proposition.

In various embodiments, an independent skill-wager element wagering system including a process controller operatively connected to a wagering subcontroller and operatively connected to an interactive controller may provide for simplified communication protocols for communications of the wagering subcontroller as the wagering subcontroller may receive skill-wager proposition requests and communicate determined skill-wager propositions having random components without regard to a nature of an interactive application provided by the interactive controller.

In some embodiments, an independent skill-wager element wagering system including a process controller operatively connecting a wagering subcontroller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, an independent skill-wager element wagering system including a process controller operatively connecting a wagering subcontroller to an interactive controller provides for operation of the interactive controller in an unsecure location or manner, while providing for operation of the wagering subcontroller in a secure location or manner.

In some embodiments, an independent skill-wager element wagering system including a process controller operatively connecting a wagering subcontroller to an interactive controller allows the skill wagering system to have regulated components coupled to unregulated components in a heterogeneous regulated environment. For example, in several such embodiments, the interactive controller may be a device that is not regulated by a wagering regulatory agency whereas the wagering subcontroller is regulated by the wagering regulatory agency. A process controller of an independent skill-wager element wagering system may provide for isolation of the processing of the interactive controller from the processing of the wagering subcontroller. In such a heterogeneous regulatory environment, the process controller may or may not be itself a regulated by the wagering regulatory authority. In addition, components of an interactive application executed by the interactive controller may be either regulated or unregulated by the wagering regulatory agency.

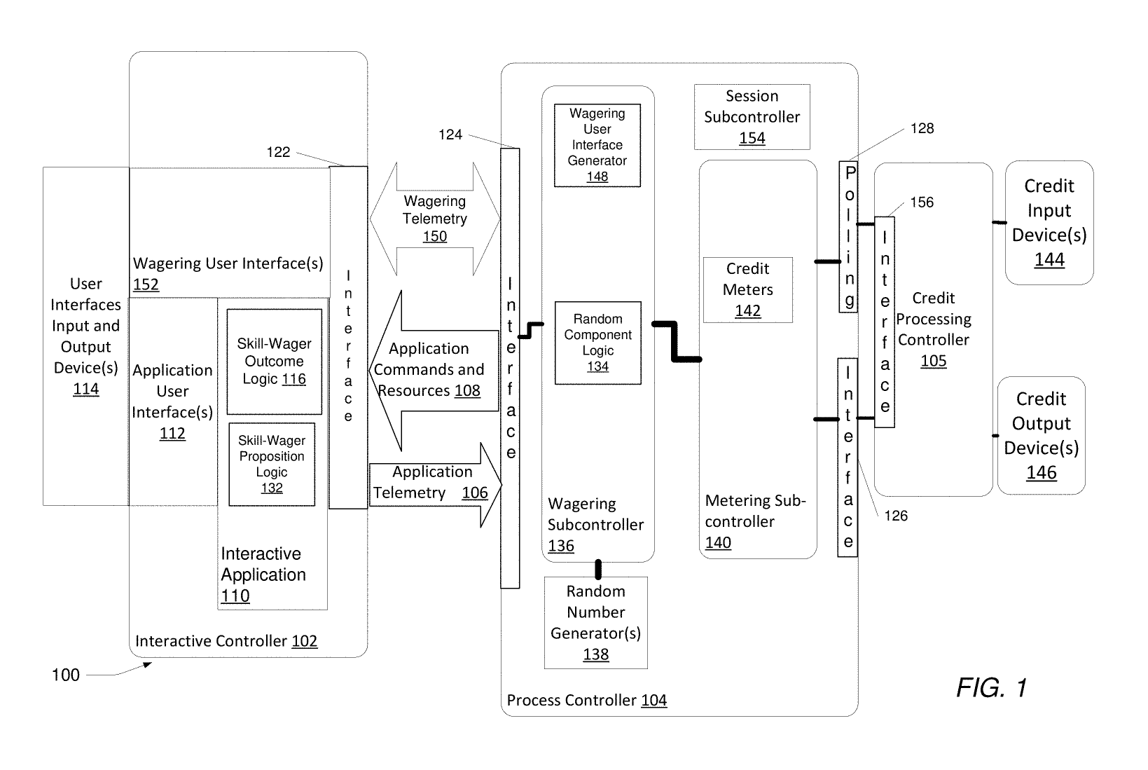

FIG. 1 is a diagram of a structure of an independent skill-wager element wagering system in accordance with various embodiments of the invention. The independent skill-wager element wagering system 100 includes an interactive controller 102, a process controller 104, and a credit processing controller 105. The interactive controller 102 is operatively connected to, and communicates with, the process controller 104. The process controller 104 is also operatively connected to, and communicates with, the credit processing controller 105.

In various embodiments, the interactive controller 102 executes an interactive application 110 and provides one or more user interface input and output devices 114 so that one or more players can interact with the interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user interface input devices to detect player interactions with the interactive controller 102 and generates an interactive user interface that is presented to the player utilizing the user interface output devices.

In some embodiments, one or more components an interactive controller are housed in an enclosure such as a housing, cabinet, casing or the like. The enclosure further includes one or more player accessible openings or surfaces that constructed to mount the user interface input devices and/or the user interface output devices.

The interactive controller 102 is operatively connected to, and communicates with, the process controller 104. The interactive controller 102 receives application command and resource data 108 that may include, but is not limited to, random components, skill-wager proposition data, application command data, and resource data from the process controller 104. Via the communication of the application command and resource data 108, the process controller 104 can control the operation of the interactive controller 102 by communicating control parameters to the interactive application 110 during the interactive application's execution by the interactive controller 102.

In many embodiments, the interactive application 110 of the interactive controller 102 utilizes skill-wager proposition logic 132 to generate one or more independent skill-wager elements using random components received from the process controller 104 as part of the application command and resource data 108.

In an example embodiment, a skill-wager proposition is generated by executing proposition commands included in a script written in a scripting language.

In some embodiments, during execution of the interactive application 110 by the interactive controller 102, the interactive controller 102 communicates, as application telemetry data 106, player interactions with one or more interactive elements of the application user interfaces 112 of the interactive application to the process controller 104. The application telemetry data 106 may include, but is not limited to, application environment variables that indicate the state of the interactive application 110, interactive controller data indicating a state of the interactive controller 102, player actions and interactions between one or more players and the interactive application 110 provided by the interactive controller 102, and utilization of interactive elements including independent skill-wager elements in the interactive application 110 by one or more players.

In some embodiments, the application telemetry data 106 includes a skill-wager outcome as determined by the interactive application 110 using skill-wager outcome logic 116, and player interactions with one or more application user interfaces 112 of the interactive application. In many embodiments, the application telemetry data includes a request by the interactive application for a random component for utilization during a player's interaction with an independent skill-wager element.

In some embodiments, the interactive application 110 is a skill-based interactive application. In such embodiments, execution of the skill-based interactive application 110 by the interactive controller 102 is based on one or more players' skillful interaction with the interactive application 110, such as, but not limited to, the players' utilization of the interactive elements of the interactive application during the players' skillful interaction with the skill-based interactive application. In such an embodiment, the process controller 104 communicates with the interactive controller 102 in order to allow the coupling of the skill-based interactive application to random components determined by the wagering subcontroller 136 of the process controller 104.

In some embodiments, the interactive application 110 uses skill-wager proposition data, interactive application command data, and/or resource data included in the application commands and resources 108 to generate a skill-wager proposition presented to one or more players as one or more application user interfaces 112 using one or more output devices of user interface and output device(s) 114. The one or more players skillfully interact with the one or more application user interfaces 112 using one or more of input devices of the user interface input and output devices 114. The interactive application 110 determines a skill-wager outcome based on the skillful interactions of the one or more players and communicates data of the determined skill-wager outcome to the process controller 104 as part of the application telemetry 106. In some embodiments, the interactive application 110 also communicates as part of the application telemetry data 106, data encoding the one or more players' interactions with the interactive application 110.

In some embodiments, the skill-wager outcome logic 116 and the skill-wager proposition generated by the skill-wager proposition logic 132 are for a skill-wager proposition for one or more players. The interactive application 110 determines one or more skill-wager outcomes based on the skill-wager proposition and the one or more players' skillful interactions with the interactive application. The interactive controller communicates data of the one or more skill-wager outcomes to the process controller 104 as part of the application telemetry data 106.

In some embodiments, when a player interacts with an independent skill-wager element within the interactive application 110, the interactive application 110 generates a request for a random result communicated by the interactive application 110 to the process controller 104. In response, the wagering subcontroller 136 of the process controller 104 generates a random result using one or more random number generators 138. The process controller 104 communicates the one or more random results as part of the application command and resource data 108 to the interactive application 110 and the interactive controller 102. The independent skill-wager element utilizes the one or more random results to determine in part one or more skill-wager outcomes.

In some embodiments, the interactive controller 102 includes one or more sensors that sense various aspects of the physical environment of the interactive controller 102. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes one or more wagering user interfaces 118 used to display wagering data, via one or more of the user interface input and output devices 114, to one or more players.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a skill-wager proposition resolved for one or more players when skillfully interacting with the interactive application 110 provided by the interactive controller 102, and a random component, provided in-part by a wagering subcontroller 136.

In various embodiments, the process controller 104 includes a wagering subcontroller 136 having a rule-based decision engine that receives application telemetry data 106 from the interactive controller 102. The rule-based decision engine has random component logic 134. The decision engine uses the application telemetry data 106, along with random component logic 134, and a random result generated by one or more random number generators (RNGs) 138 to generate one or more random components.

In an embodiment, the application telemetry data 106 used by the decision engine encodes data about the operation of the interactive application 110 executed by the interactive controller 102.

In some embodiments, the application telemetry data 106 encodes interactions of a player, such as a player's interaction with an interactive element of the interactive application 110.

In many embodiments, the application telemetry data 106 includes a state of the interactive application 110, such as values of variables that change as the interactive application 110 executes.

In several embodiments, a decision engine includes one or more rules as part of random component logic 134 used by the decision engine to determine how a random component should generated. Each rule includes one or more variable values constituting a pattern that is to be matched by the wagering subcontroller 136 using the decision engine to one or more variable values encoded in the application telemetry data 106. Each rule also includes one or more actions that are to be taken if the pattern is matched. Actions can include automatically generating the random component in accordance with the random component logic 134 and a random result generated by one or more random number generators 138. During operation, the decision engine receives application telemetry data 106 from the interactive controller 102 via interface 160. The decision engine performs a matching process of matching the variable values encoded in the application telemetry data 106 to one or more variable patterns of one or more rules. If a match between the variable values and a pattern of a rule is determined, then the wagering subcontroller 136 performs the action of the matched rule.

In some embodiments, the wagering subcontroller 136 uses the random component in conjunction with the application telemetry data 106 and skill-wager proposition logic, to automatically generate application command and resource data 108 including skill-wager proposition data of a skill-wager proposition that the process controller 104 communicates to the interactive controller 102 via interfaces 124 and 122.

In some embodiments, a decision engine includes one or more rules as part of skill-wager proposition logic used by the decision engine to automatically generate application command and resource data 108 that is then communicated to the interactive controller 102. Each rule includes one or more variable values constituting a pattern that is to be matched to one or more variable values encoded in the application telemetry data 106 and the random component. Each rule also includes one or more actions that are to be automatically taken by the wagering subcontroller 136 if the pattern is matched. Actions can include automatically generating skill-wager proposition data, interactive application command data, and/or resource data 108 and using the skill-wager proposition data, interactive application command data, and/or resource data 108 to control the interactive controller 102 to affect execution of the interactive application 110 as described herein. In operation, wagering subcontroller 104 uses the decision engine to match the variable values encoded in the in the random component data to one or more patterns of one or more rules of the skill-wager proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the random component to generate the skill-wager proposition data, interactive application command data, and/or resource data 108.

The interactive controller receives the interactive application command data and resource data 108 and automatically uses the interactive application command data, and/or resource data 108 to configure and command the processes of the interactive application 110.

In some embodiments, the interactive application 110 operates utilizing a scripting language. The interactive application 110 parses scripts written in the scripting language and executes commands encoded in the scripts and sets variable values as defined in the scripts. In operation of such embodiments, the process controller 104 automatically generates interactive application command data, and/or resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands and sets the variable values as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 automatically generates commands that are encoded into the interactive application command data, and/or resource data 108 that are communicated to the interactive controller 102. The interactive controller 102 passes the interactive application command data, and/or resource data 108 to the interactive application 110. The interactive application parses the interactive application command data, and/or resource data and automatically performs operations in accordance with the commands encoded in the interactive application command data, and/or resource data 108.

In various embodiments, the process controller 104 includes one or more interfaces, 124, 126 and 128 that operatively connect the process controller 104 to one or more interactive controllers, such as interactive controller 102, and to one or more credit processing controllers, such as credit processing controller 105.

In some embodiments, one or more of the process controller interfaces implement a process controller to device or server communication protocol employing an interprocess communication protocol so that the process controller and one or more of an interactive controller, a wagering subcontroller, and/or a session subcontroller may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive controllers, the one or more session subcontrollers and/or the one or more wagering subcontrollers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive controllers, the one or more session subcontrollers, and/or the one or more wagering subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In several embodiments, the wagering subcontroller 136 is a controller for providing one or more wagers in accordance with one or more skill-wager propositions provided by the independent skill-wager element wagering system 100. Types of value of a wager can be one or more of several different types. Types of value of a wager can include, but are not limited to, a wager of an amount of credits corresponding to a real currency or a virtual currency, a wager of an amount of application credits earned through interaction with an interactive application, a wager of an amount of interactive elements of an interactive application, and a wager of an amount of objects used in an interactive application. A skill-wager outcome determined for a wager in accordance with a skill-wager proposition can increase or decrease an amount of the type of value used in the wager, such as, but not limited to, increasing or decreasing an amount of credits for a wager of credits. In various embodiments, a skill-wager outcome determined for a wager in accordance with a skill-wager proposition can increase or decrease an amount of a type of value that is different than a type of value of the wager, such as, but not limited to, increasing an amount of an object of an interactive application for a wager of credits.

In many embodiments, the process controller 104 includes one or more random number generators (RNGs) 138 for generating random results. The wagering subcontroller uses the one or more random results along with the random component logic 130 to generate a random component of a skill-wager proposition.

In several embodiments, the process controller 104 includes a metering subcontroller 140 operatively connected to the credit processing controller 105 via interfaces 126 and 128. The metering subcontroller 140 communicates with the credit processing controller 105 to receive incoming credit data from the credit processing controller 105. The metering subcontroller 140 uses the incoming credit data to transfer credits into the independent skill-wager element wagering system and onto one or more credit meters 142. The metering subcontroller 140 communicates outgoing credit data to the credit processing controller 105 to transfer credits off of the one or more credit meters 142 and out of the independent skill-wager element wagering system.

In several embodiments, during operation, the metering subcontroller 140 communicates with the credit processing controller 105 to receive incoming credit data from the credit processing controller 105 and adds credits onto the one or more credit meters 110 at least partially on the basis of the incoming credit data. The one or more random number generators 138 execute processes that generate random results. The wagering subcontroller 136 uses the random component logic 134 and the random results to generate a random component of a skill-wager proposition. The random component is communicated by the process controller as part of the application command and resource data 108 to the interactive controller 102. The interactive application 110 uses the random component along with the skill-wager proposition logic 132 to generate a skill-wager proposition. The interactive controller uses the skill-wager proposition along with the skill-wager outcome logic 116 to generate a presentation for one or more players using the one or more user interfaces 112. One or more players interact with the one or more application user interfaces 112 through the one or more user interface input and output devices 114. The interactive application 110 determines a skill-wager outcome based on the interactions of the one or more players and communicates data of the skill-wager outcome as part of the application telemetry data 106 to the process controller 104. The wagering sub controller 136 receives the skill-wager outcome data and instructs the metering subcontroller 140 to add credits to, or deduct credits from, the one or more credit meters 110 based in part on the skill-wager outcome data. For example, in some embodiments, the metering subcontroller is instructed to add an amount of credits to a credit meter of the one or more credit meters 110 when the skill-wager outcome indicates a win for a player associated with the credit meter. In various embodiments, the metering subcontroller is instructed to deduct an amount of credits from the credit meter when the skill-wager outcome indicates a loss for the player. At an end of a wagering session, the metering subcontroller 140 transfers credits off of the one or more credit meters 110 and out of the independent skill-wager element wagering system by communicating outgoing credit data to the credit processing controller 105.

In many embodiments, the one or more random number generators 138 generate random numbers by continuously generating pseudo random numbers using a pseudo random number generator. A most current pseudo random number is stored in a buffer thus constantly refreshing the buffer. In many embodiments, the buffer is refreshed at a rate exceeding 100 times per second. When the wagering subcontroller 136 requests a random result, the wagering subcontroller 136 receives the stored most current pseudo random number from the buffer. As timing between requests for a random result is not deterministic, the resulting output from the buffer is a true random result such as a random number.

In various embodiments, the process controller 104 uses a rule-based decision engine to automatically determine an amount of application credits to award to a player based at least in part on the application telemetry data 106 including skill-wager outcome data and player interaction data with the interactive application 110 of the independent skill-wager element wagering system. In numerous embodiments, the interactive application 110 is a skill-based interactive application and the application credits are awarded for a player's skillful interaction with the interactive application 110.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and/or loss for the independent skill-wager element wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits, and/or interactive elements earned, lost or accumulated through interaction with the interactive application 110, and credits, application credits, and interactive elements amounts won, lost or accumulated as a result of an outcome of a skill-wager proposition.

In some embodiments, the skill-wager proposition data, interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives random component data that is used as a partial basis for generation of the wagering telemetry data 150 communicated to the interactive controller 102. In some embodiments, the random component data also includes data about one or more states of a wager of the skill-wager proposition. In various such embodiments, the wagering user interface generator 148 generates a random component generation process display and/or random component state display using the one or more states of the random component. The random component generation process display and/or random component state display is included in the wagering telemetry data 150 that is communicated to the interactive controller 102. The wagering process display and/or wagering state display is automatically displayed by the interactive controller 102 using the one or more wagering user interfaces 152. In other such embodiments, the one or more states of the random component are communicated to the interactive controller 102 and the interactive controller 102 is instructed to automatically generate the random component generation process display and/or random component state display of the one or more wagering user interfaces 152 using the one or more states of the random component for display.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wagering outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wagering outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering subcontroller to determine an amount of credit or interactive elements available and other wagering metrics of a skill-wager proposition. Thus, the process controller 104 may potentially affect an amount of credits in play for participation in the wagering events of the skill-wager proposition provided by the wagering subcontroller. In some embodiments, the process controller 104 can also couple to a centralized server for exchanging various data related to players and the activities of the players during utilization of an independent skill-wager element wagering system.

In a number of embodiments, communication of random component determination commands and skill-wager proposition commands between the wagering subcontroller 136 and the process controller 104 can further be used to communicate various wagering control factors that the wagering subcontroller uses as input. Examples of wagering control factors include, but are not limited to, an amount of credits, amount of application credits, amount of interactive elements, or amounts of objects consumed wager, and/or a player's election to enter a jackpot round.

In many embodiments, two or more players can be engaged in using the interactive application 110 executed by the interactive controller 102. In various embodiments, an independent skill-wager element wagering system can include an interactive application 110 that provides a skill-based interactive application that includes head-to-head play between a single player and a computing device, between two or more players against one another, or multiple players playing against a computer device and/or each other. In some embodiments, the interactive application 110 can be a skill-based interactive application where the player is not skillfully playing against the computer or any other player such as skill-based interactive applications where the player is effectively skillfully playing against himself or herself.

In some embodiments, the process controller 104 utilizes the one or more wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to communicate aspects of a skill-wager proposition to a player including, but not limited to, amount of credits, application credits, interactive elements, or objects in play, and amounts of credits, application credits, interactive elements, or objects available.

In a number of embodiments, the wagering subcontroller 136 can accept skill-wager proposition factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering subcontroller, such that an increase/decrease in a wagered amount can be related to the change in player profile of the player in the interactive application. In this manner, a player can control a wager amount per wagering event in accordance with the skill-wager proposition with the change mapping to a parameter or component that is applicable to the interactive application experience.

In some embodiments, the process controller 104 includes a session subcontroller 154 is used to regulate an independent skill-wager element wagering system session.

In various embodiments, the session subcontroller 154 includes one or more session subcontroller interfaces that operatively connect the session subcontroller 154 to one or more wagering subcontrollers, metering subcontrollers and pooled bet subcontrollers through their respective interfaces.

In some embodiments, one or more of the session subcontroller interfaces implement a session subcontroller to device or server communication protocol employing an interprocess communication protocol so that the session subcontroller and one or more of an interactive controller, a wagering subcontroller, and/or a process controller may be implemented on the same device. In operation, the session subcontroller interfaces provide application programming interfaces or the like that are used by the session subcontroller to communicate outgoing data and receive incoming data by passing parameter data to another process or application running on the same device.

In some embodiments, one or more of the session subcontroller interfaces implement a session subcontroller communication protocol employing an interdevice communication protocol so that the session subcontroller may be implemented on a device separate from the one or more interactive controllers, the one or more process controllers and/or the one or more wagering subcontrollers. The interdevice protocol may utilize a wired communication bus or wireless connection as a physical layer. In various embodiments, one or more of the session subcontroller interfaces implement a session subcontroller communication protocol employing a networking protocol so that the process session subcontroller may be operatively connected to the one or more interactive controllers, the one or more process controllers, and/or the one or more wagering subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more session subcontroller interfaces communicate outgoing data to an external device or server by encoding the data into a signal and transmitting the signal to the external device or server. The one or more session subcontroller interfaces receive incoming data from an external device or server by receiving a signal transmitted by the external device or server and decoding the signal to obtain the incoming data.

In various embodiments, components of the process controller 104 communicate session data to the session subcontroller. The session data may include, but is not limited to, player data, interactive controller data, pooled bet and side bet data, process controller data and wagering subcontroller data used by the session subcontroller to regulate an independent skill-wager element wagering system session.

In some embodiments, the session subcontroller 154 may also assert control of an independent skill-wager element wagering system session by communicating session control data to components of the process controller 104. Such control may include, but is not limited to, commanding the process controller 104 to end an independent skill-wager element wagering system session, initiating wagering in an independent skill-wager element wagering system session, ending wagering in an independent skill-wager element wagering system session but not ending a player's use of the interactive application portion of the independent skill-wager element wagering system, and changing from real credit wagering in an independent skill-wager element wagering system to virtual credit wagering, or vice versa.

In many embodiments, the session subcontroller 154 manages player profiles for a plurality of players. The session subcontroller 154 stores and manages data about players in order to provide authentication and authorization of players of the independent skill-wager element wagering system 100. In some embodiments, the session subcontroller 154 also manages geolocation information to ensure that the independent skill-wager element wagering system 100 is only used by players in jurisdictions were wagering is approved. In various embodiments, the session subcontroller 154 stores application credits that are associated with the player's use of the interactive application of the independent skill-wager element wagering system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154 via interfaces 122 and 124.

In some embodiments, the wagering subcontroller 136 communicates wagering session data to the session subcontroller 154. In various embodiments, the session subcontroller communicates wagering session control data to the wagering subcontroller 136.

In some embodiments, a process controller operates as an interface between an interactive controller and a wagering subcontroller. By virtue of this construction, the wagering subcontroller is isolated from the interactive controller allowing the interactive controller to operate in an unregulated environment while allowing the wagering subcontroller to operate in a regulated environment.

In some embodiments, a single wagering subcontroller may provide services to two or more interactive controllers and/or two or more process controllers, thus allowing an independent skill-wager element wagering system to operate over a large range of scaling.

In various embodiments, multiple types of interactive controllers using different operating systems may be interfaced to a single type of process controller and/or wagering subcontroller without requiring customization of the process controller and/or the wagering subcontroller.

In many embodiments, an interactive controller may be provided as a player device under control of a player while maintaining the wagering subcontroller in an environment under the control of a regulated operator of wagering equipment.

In several embodiments, data communicated between the controllers may be encrypted to increase security of the independent skill-wager element wagering system.

In some embodiments, a process controller isolates random component logic 134 as regulated logic and skill-wager proposition logic 132 as unregulated logic from a regulated wagering subcontroller, thus allowing errors in the skill-wager proposition logic and/or random component logic to be corrected, new skill-wager proposition logic and/or random component logic to be used, or modifications to be made to the skill-wager proposition logic and/or random component logic without a need for regulatory approval.

In various embodiments, an interactive application may require extensive processing resources from an interactive controller leaving few processing resources for the functions performed by a process controller and/or a wagering subcontroller. By virtue of the architecture described herein, processing loads may be distributed across multiple devices such that operations of the interactive controller may be dedicated to the interactive application and the processes of the process controller and/or wagering subcontroller are not burdened by the requirements of the interactive application.

In many embodiments, an independent skill-wager element wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of an independent skill-wager element wagering system are distributed in close proximity to each other and communicate using a local area network and/or a communication bus. In several embodiments, an interactive controller and a process controller of an independent skill-wager element wagering system are in a common location and communicate with an external wagering subcontroller. In some embodiments, a process controller and a wagering subcontroller of an independent skill-wager element wagering system are in a common location and communicate with an external interactive controller. In many embodiments, an interactive controller, a process controller, and a wagering subcontroller of an independent skill-wager element wagering system are located in a common location. In some embodiments, a session subcontroller is located in a common location with a process controller and/or a wagering subcontroller.

In various embodiments, these multiple devices can be constructed from or configured using a single device or a plurality of devices such that an independent skill-wager element wagering system is executed as a system in a virtualized space such as, but not limited to, where a wagering subcontroller and a process controller are large scale centralized servers in the cloud operatively connected to widely distributed interactive controllers via a wide area network such as the Internet or a local area network. In such embodiments, the components of an independent skill-wager element wagering system may communicate using a networking protocol or other type of device-to-device communications protocol.

In some embodiments, an independent skill-wager element wagering system is deployed over a local area network or a wide area network in an interactive configuration. An interactive configuration of an independent skill-wager element wagering system includes an interactive controller operatively connected by a network to a process controller and a wagering subcontroller.

In some embodiments, an independent skill-wager element wagering system is deployed over a local area network or a wide area network in a mobile configuration. A mobile configuration of an independent skill-wager element wagering system is useful for deployment over a wireless communication network, such as a wireless local area network or a wireless telecommunications network. A mobile configuration of an independent skill-wager element wagering system includes an interactive controller operatively connected by a wireless network to a process controller and a wagering subcontroller.

In several embodiments, a centralized process controller is operatively connected to one or more interactive controllers and one or more wagering subcontrollers using a communication link. The centralized process controller can perform the functionality of a process controller across various independent skill-wager element wagering systems.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, the process controller 104 is operatively connected to a central determination controller (not shown). In operation, when a wagering subcontroller of the process controller 104 needs to determine a random result, the wagering subcontroller communicates a request to the central determination controller for the random result. The central determination controller receives the random result request and generates a random result in response to the random result request. The central determination controller communicates data of the random result to the process controller 104. The processing controller 104 receives the data of the random result and utilizes the random result as described herein. In some embodiments, the random result is drawn from a pool of pre-determined random results.

In many embodiments, the credit processing controller 105 operatively connects to one or more credit input devices for generating incoming credit data from a credit input. Credit inputs can include, but are not limited to, credit items used to transfer credits. The incoming credit data are communicated by the credit processing controller 105 to the metering subcontroller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing controller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 105 is operatively connected to, and communicates with, a TITO system or the like to determine incoming credit data representing amounts of credits to be transferred into the independent skill-wager element wagering system and to determine outgoing credit data representing amounts of credits to be transferred out of the independent skill-wager element wagering system. In operation, the credit processing controller 105 communicates with a connected credit input device, such as a bill validator/ticket scanner, used to scan a credit input in the form of a TITO ticket having indicia of credit account data of a credit account of the TITO system. The credit processing controller 105 communicates the credit account data to the TITO system. The TITO system uses the credit account data to determine an amount of credits to transfer to the credit processing controller 105, and thus to the metering subcontroller 140 of the process controller 104. The TITO system communicates the amount of credits to the credit processing controller 105. The credit processing controller 105 communicates the amount of credits as incoming credit data to the metering subcontroller 140 and the metering subcontroller 140 credits one or more credit meters 142 with the amount of credits so that the credits can be used when a player makes wagers using the independent skill-wager element wagering system 100.

In many embodiments, the credit processing controller 105 is operatively connected to a bill validator/ticket scanner as one of the one or more credit input devices 144. The credit processing controller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the independent skill-wager element wagering system 100.

In some embodiments, the credit processing controller 105 can use a TITO system along with a ticket or voucher printer as one of the one or more credit output devices 146 to generate a TITO ticket as a credit output for a player. In operation, the credit processing controller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 105. The credit processing controller 105 uses the ticket or voucher printer to print indicia of the credit account data onto a TITO ticket or voucher as a credit output.

In various embodiments, a credit processing interface 156 resident in the credit processing controller 105 provides an interface between the credit processing controller 156 and the process controller 104.

In some embodiments, the application control interface 156 implements a credit processing controller to process controller communication protocol employing an interprocess communication protocol so that the interactive controller 104 and the credit processing controller 105 may be implemented on the same device. In operation, the credit processing interface 156 provides application programming interfaces that are used by the credit processing controller 105 to communicate outgoing data and receive incoming data by passing parameter data to another process or application.

In some embodiments, the credit processing interface 156 implements an interactive controller to credit processing controller communication protocol employing an interdevice communication protocol so that the interactive controller and the credit processing controller may be implemented on different devices. The interdevice protocol may utilize a wired communication bus or wireless connection as a physical layer.

In various embodiments, the credit processing interface 156 implements an interactive controller to credit processing controller communication protocol employing a networking protocol so that the process controller 104 and the credit processing controller 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing controller 105 provides an interface to an electronic payment management system (not shown) such as an electronic wallet or the like. The electronic payment system provides credit account data that is used for generating incoming credit data as a credit input and outgoing credit data as a credit output.

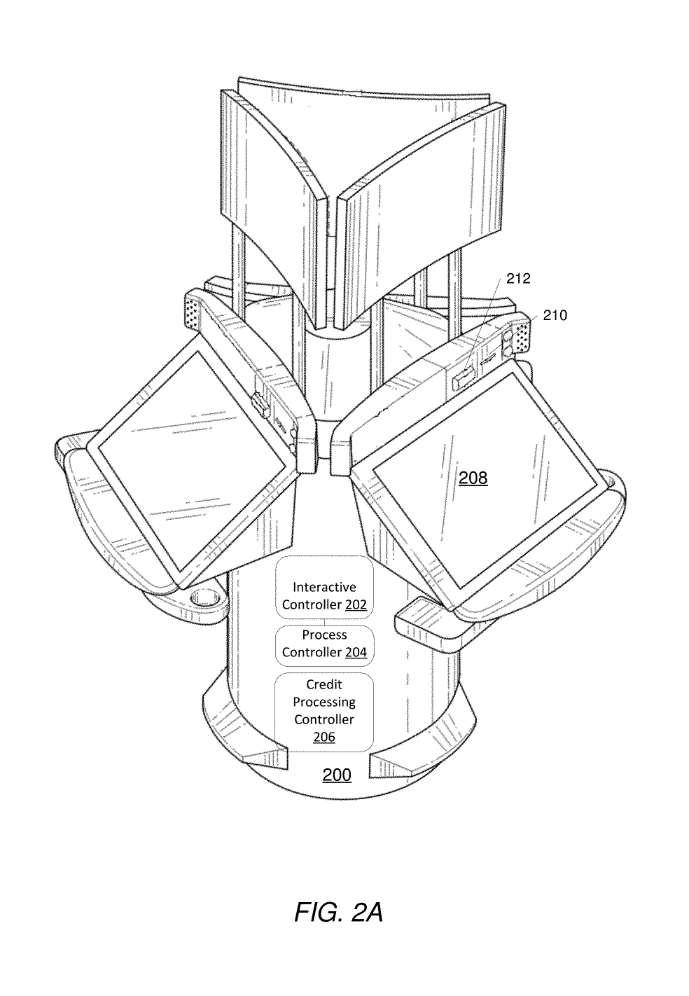

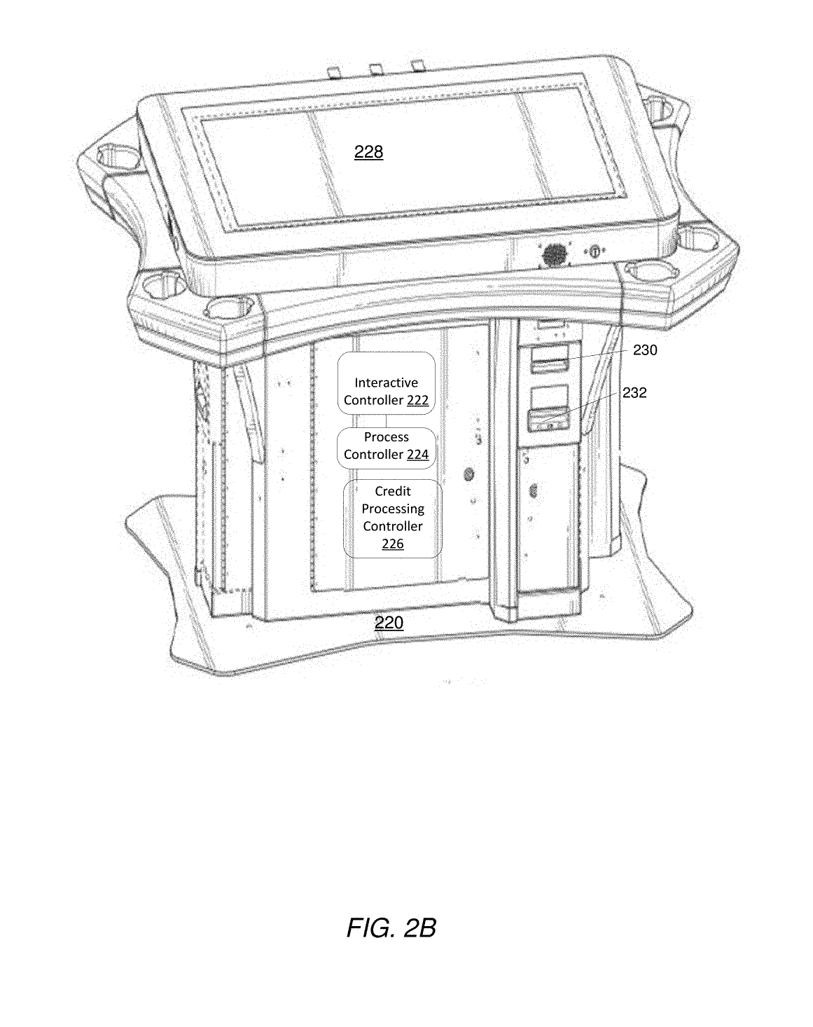

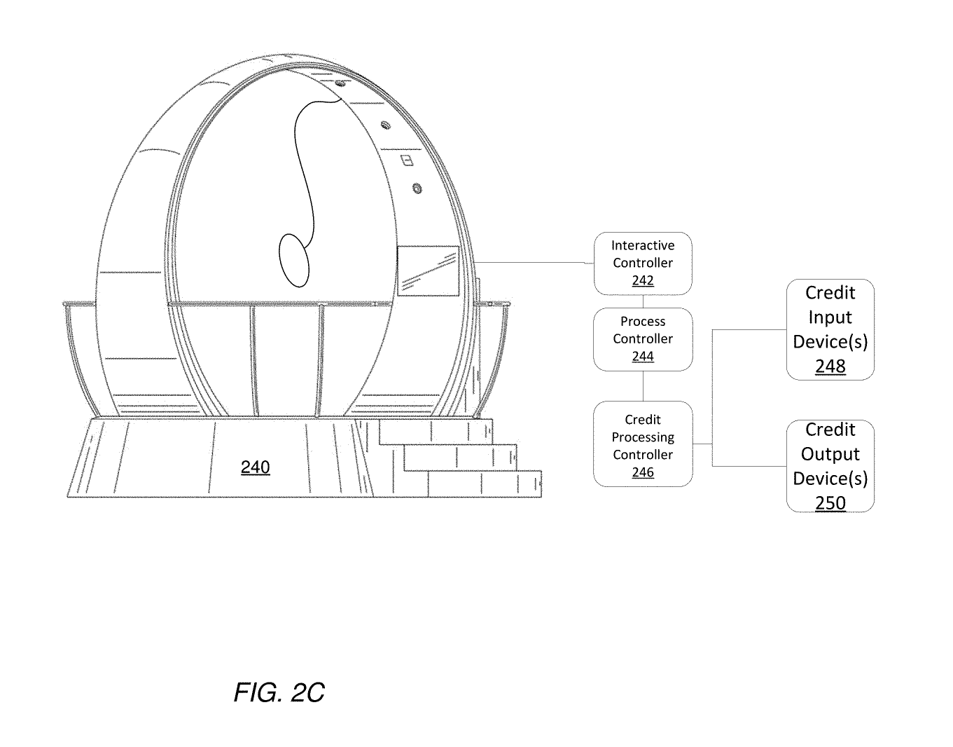

FIG. 2A is a diagram of an electronic gaming machine configuration of an independent skill-wager element wagering system in accordance with various embodiments of the invention. Electronic gaming machine configurations of an independent skill-wager element wagering system include, but are not limited to, electronic gaming machines such as slot machines, table games, video arcade consoles and the like. An electronic gaming machine configuration of an independent skill-wager element wagering system 200 includes an interactive controller 202, a process controller 204 and a credit processing controller 206 contained in an enclosure such as a housing, cabinet, casing or the like. The enclosure may further include one or more player accessible openings or surfaces that may be used to mount one or more player accessible user input devices and user output devices 208, one or more player accessible credit input devices 210 and one or more player accessible credit output devices 212. The interactive controller 202 communicates with the user input devices to detect player interactions with the independent skill-wager element wagering system and commands and controls the user output devices to provide a user interface to one or more players of the independent skill-wager element wagering system as described herein. The process controller 204 communicates with the credit processing controller 206 or player credit processing devices 210 and 212 to transfer credits into and out of the independent skill-wager element wagering system as described herein.

In various embodiments, the process controller 204 is operatively connected to the credit processing controller 206. In many embodiments, the credit processing controller 206 is operatively connected to one or more credit input devices 210 for generating incoming credit data from a credit input as described herein. The incoming credit data are communicated to the process controller 204. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller 206 is operatively connected to the one or more credit output devices 212 for generating a credit output based on outgoing credit data communicated from the process controller 204. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 206 is operatively connected to, and communicates with, a TITO system (not shown) or the like to determine incoming credit data representing amounts of credits to be transferred into the independent skill-wager element wagering system 200 and to determine outgoing credit data representing amounts of credits to be transferred out of the independent skill-wager element wagering system 200. In operation, the credit processing controller 206 communicates with one of the one or more connected credit input devices 210, such as a bill validator/ticket scanner, used to scan a credit input in the form of a TITO ticket having indicia of credit account data of a credit account of the TITO system. The credit processing controller 206 communicates the credit account data to the TITO system. The TITO system uses the credit account data to determine an amount of credits to transfer to the credit processing controller 206 of the independent skill-wager element wagering system 200. The TITO system communicates the amount of credits to the credit processing controller 206. The credit processing controller 206 communicates the amount of credits as incoming credit data to the process controller 204 which credits one or more credit meters with the amount of credits so that the credits can be used when a player makes wagers using the independent skill-wager element wagering system 200.

In many embodiments, the credit processing controller 206 includes a bill validator/ticket scanner as one of the one or more credit input devices 210. The credit processing controller 206 communicates with the bill validator/ticket scanner to scan currency used as a credit input to determine an amount of credits as incoming credit data to transfer credit to one or more credit meters associated with one or more players. The process controller 204 credits the one or more credit meters with the amount of credits so that the credits can be used when a player makes wagers using the independent skill-wager element wagering system 200.

In some embodiments, the credit processing controller 206 can use the TITO system along with a ticket or voucher printer as one of the one or more credit output devices 212 to generate a TITO ticket as a credit output for a player. In operation, the credit processing controller 206 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 206. The credit processing controller 206 uses the ticket or voucher printer to print indicia of the credit account data onto a TITO ticket as a credit output.

In various embodiments, the credit processing controller 206 provides an interface to an electronic payment system 216 such an electronic wallet or the like. The electronic payment system 216 provides credit account data that is used for generating incoming credit data as a credit input and outgoing credit data as a credit output.

In some embodiments, the process controller 204 is operatively connected to a central determination controller (not shown). In operation, when a wagering subcontroller of the process controller 204 needs to determine a random result, the wagering subcontroller communicates a request to the central determination controller for the random result. The central determination controller receives the random result request and generates a random result in response to the random result request. The central determination controller communicates data of the random result to the process controller 204. The processing controller 204 receives the data of the random result and utilizes the random result as described herein. In some embodiments, the random result is drawn from a pool of pre-determined random results.

In various embodiments, the wagering process controller 204 may be operatively connected to a progressive controller along (not shown) with one or more other process controllers of one or more other independent skill-wager element wagering systems. The progressive controller provides services for the collection and provision of credits used by the process controller 204 to provide random results that have a progressive or pooling component.

FIG. 2B is a diagram of a multiplayer electronic gaming machine configuration of an independent skill-wager element wagering system in accordance with various embodiments of the invention. Types of a multiplayer electronic gaming machine configuration an independent skill-wager element wagering system include, but are not limited to, multiplayer electronic gaming machines, multiplayer slot machines, multiplayer table gaming devices, multiplayer video arcade consoles and the like. A multiplayer electronic gaming machine configuration of an independent skill-wager element wagering system 220 includes an interactive controller 222, a process controller 224 and a credit processing controller 226 contained in an enclosure such as a housing, cabinet, casing or the like. The enclosure may further include one or more player accessible openings or surfaces that may be used to mount one or more player accessible user input devices and user output devices 228, one or more player accessible credit input devices 230 and one or more player accessible credit output devices 212.

In some embodiments, two or more sets of credit input devices and credit output devices are provided so that each player of the multiplayer electronic gaming machine configuration of an independent skill-wager element wagering system 220 can have an associated set of credit input devices and credit output devices.

The interactive controller 222 communicates with the user input devices to detect player interactions with the independent skill-wager element wagering system and commands and controls the user output devices to provide a user interface to one or more players of the independent skill-wager element wagering system as described herein. The process controller 224 communicates with the credit processing controller 226 or player credit processing devices 230 and 232 to transfer credits into and out of the independent skill-wager element wagering system as described herein.

In many embodiments, the process controller 224 is operatively connected to an external session subcontroller (not shown). The session subcontroller may provide session control for a wagering session or may provide services for management of a player account for the storage of player points, application credits and the like.

In various embodiments, the process controller 224 is operatively connected to the credit processing controller 226. In many embodiments, the credit processing controller 226 is operatively connected to one or more credit input devices 230 for generating incoming credit data from a credit input as described herein. The incoming credit data are communicated to the process controller 224. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller 226 is operatively connected to the one or more credit output devices 232 for generating a credit output based on outgoing credit data communicated from the process controller 224. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 226 is operatively connected to, and communicates with, a TITO system (not shown) or the like to determine incoming credit data representing amounts of credits to be transferred into the independent skill-wager element wagering system 220 and to determine outgoing credit data representing amounts of credits to be transferred out of the independent skill-wager element wagering system 220. In operation, the credit processing controller 226 communicates with one of the one or more connected credit input devices 230, such as a bill validator/ticket scanner, used to scan a credit input in the form of a TITO ticket having indicia of credit account data of a credit account of the TITO system. The credit processing controller 226 communicates the credit account data to the TITO system. The TITO system uses the credit account data to determine an amount of credits to transfer to the credit processing controller 226 of the independent skill-wager element wagering system 220. The TITO system communicates the amount of credits to the credit processing controller 226. The credit processing controller 226 communicates the amount of credits as incoming credit data to the process controller 224 which credits one or more credit meters with the amount of credits so that the credits can be used when a player makes wagers using the independent skill-wager element wagering system 220.

In many embodiments, the credit processing controller 226 includes a bill validator/ticket scanner as one of the one or more credit input devices 230. The credit processing controller 226 communicates with the bill validator/ticket scanner to scan currency used as a credit input to determine an amount of credits as incoming credit data to transfer credit to one or more credit meters associated with one or more players. The process controller 224 credits the one or more credit meters with the amount of credits so that the credits can be used when a player makes wagers using the independent skill-wager element wagering system 220.

In some embodiments, the credit processing controller 226 can use the TITO system along with a ticket or voucher printer as one of the one or more credit output devices 232 to generate a TITO ticket as a credit output for a player. In operation, the credit processing controller 226 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 226. The credit processing controller 226 uses the ticket or voucher printer to print indicia of the credit account data onto a TITO ticket as a credit output.

In various embodiments, the credit processing controller 226 provides an interface to an electronic payment system 236 such an electronic wallet or the like. The electronic payment system 236 provides credit account data that is used for generating incoming credit data as a credit input and outgoing credit data as a credit output.

In some embodiments, the process controller 224 is operatively connected to a central determination controller (not shown). In operation, when a wagering subcontroller of the process controller 224 needs to determine a random result, the wagering subcontroller communicates a request to the central determination controller for the random result. The central determination controller receives the random result request and generates a random result in response to the random result request. The central determination controller communicates data of the random result to the process controller 224. The processing controller 224 receives the data of the random result and utilizes the random result as described herein. In some embodiments, the random result is drawn from a pool of pre-determined random results.

In various embodiments, the wagering process controller 224 may be operatively connected to a progressive controller along (not shown) with one or more other process controllers of one or more other independent skill-wager element wagering systems. The progressive controller provides services for the collection and provision of credits used by the process controller 224 to provide random results that have a progressive or pooling component.

FIG. 2C is a diagram of virtual reality gaming machine configuration of an independent skill-wager element wagering system in accordance with various embodiments of the invention. Types of a virtual reality gaming machine configuration of an independent skill-wager element wagering system include, but are not limited to, virtual reality gaming machines, virtual reality slot machines, virtual reality gaming devices, virtual reality arcade consoles and the like. A virtual reality gaming machine configuration 240 of an independent skill-wager element wagering system includes an interactive controller 242, a process controller 244 and a credit processing controller 246 contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of an independent skill-wager element wagering system further includes a player area having virtual reality sensors for sensing player interactions and/or player movements within the player area, a player headset having a stereoscopic visual display for presentation of a stereoscopic presentation to a player, headphones for presenting a stereophonic sound presentation to a player, and one or more subwoofers for providing a hepatic or low frequency auditory presentation to the player.

The interactive controller communicates with the user input devices to detect player interactions with the virtual reality independent skill-wager element wagering system and commands and controls the user output devices to provide a user interface to one or more players of the virtual reality independent skill-wager element wagering system as described herein. The process controller communicates with the credit processing controller or player credit processing devices and to transfer credits into and out of the independent skill-wager element wagering system as described herein.

In many embodiments, the process controller is further connected to one or more side betting terminals (not shown) that enable spectators of a player using the virtual reality independent skill-wager element wagering system to make side bets based on the performance of the player.

In many embodiments, the process controller is operatively connected to an external session subcontroller (not shown). The session subcontroller may provide session control for a wagering session or may provide services for management of a player account for the storage of player points, application credits and the like.

In various embodiments, the process controller is operatively connected to the credit processing controller. In many embodiments, the credit processing controller is operatively connected to one or more credit input devices 248 for generating incoming credit data from a credit input as described herein. The incoming credit data are communicated to the process controller. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validators and/or coin validators that receive and validate paper and/or coin currency or tokens.

In various embodiments, the credit processing controller is operatively connected to the one or more credit output devices 250 for generating a credit output based on outgoing credit data communicated from the process controller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller is operatively connected to, and communicates with, a TITO system (not shown) or the like to determine incoming credit data representing amounts of credits to be transferred into the independent skill-wager element wagering system and to determine outgoing credit data representing amounts of credits to be transferred out of the independent skill-wager element wagering system. In operation, the credit processing controller communicates with one of the one or more connected credit input devices, such as a bill validator/ticket scanner, used to scan a credit input in the form of a TITO ticket having indicia of credit account data of a credit account of the TITO system. The credit processing controller communicates the credit account data to the TITO system. The TITO system uses the credit account data to determine an amount of credits to transfer to the credit processing controller of the independent skill-wager element wagering system. The TITO system communicates the amount of credits to the credit processing controller. The credit processing controller communicates the amount of credits as incoming credit data to the process controller which credits one or more credit meters with the amount of credits so that the credits can be used when a player makes wagers using the independent skill-wager element wagering system.

In many embodiments, the credit processing controller includes a bill validator/ticket scanner as one of the one or more credit input devices. The credit processing controller communicates with the bill validator/ticket scanner to scan currency used as a credit input to determine an amount of credits as incoming credit data to transfer credit to one or more credit meters associated with one or more players. The process controller credits the one or more credit meters with the amount of credits so that the credits can be used when a player makes wagers using the independent skill-wager element wagering system.

In some embodiments, the credit processing controller can use the TITO system along with a ticket or voucher printer as one of the one or more credit output devices to generate a TITO ticket as a credit output for a player. In operation, the credit processing controller communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller. The credit processing controller uses the ticket or voucher printer to print indicia of the credit account data onto a TITO ticket as a credit output.

In various embodiments, the credit processing controller provides an interface to an electronic payment system such an electronic wallet or the like. The electronic payment system provides credit account data that is used for generating incoming credit data as a credit input and outgoing credit data as a credit output.

In some embodiments, the process controller is operatively connected to a central determination controller (not shown). In operation, when a wagering subcontroller of the process controller needs to determine a random result, the wagering subcontroller communicates a request to the central determination controller for the random result. The central determination controller receives the random result request and generates a random result in response to the random result request. The central determination controller communicates data of the random result to the process controller. The processing controller receives the data of the random result and utilizes the random result as described herein. In some embodiments, the random result is drawn from a pool of pre-determined random results.

In various embodiments, the wagering process controller may be operatively connected to a progressive controller along (not shown) with one or more other process controllers of one or more other independent skill-wager element wagering systems. The progressive controller provides services for the collection and provision of credits used by the process controller to provide random results that have a progressive or pooling component.

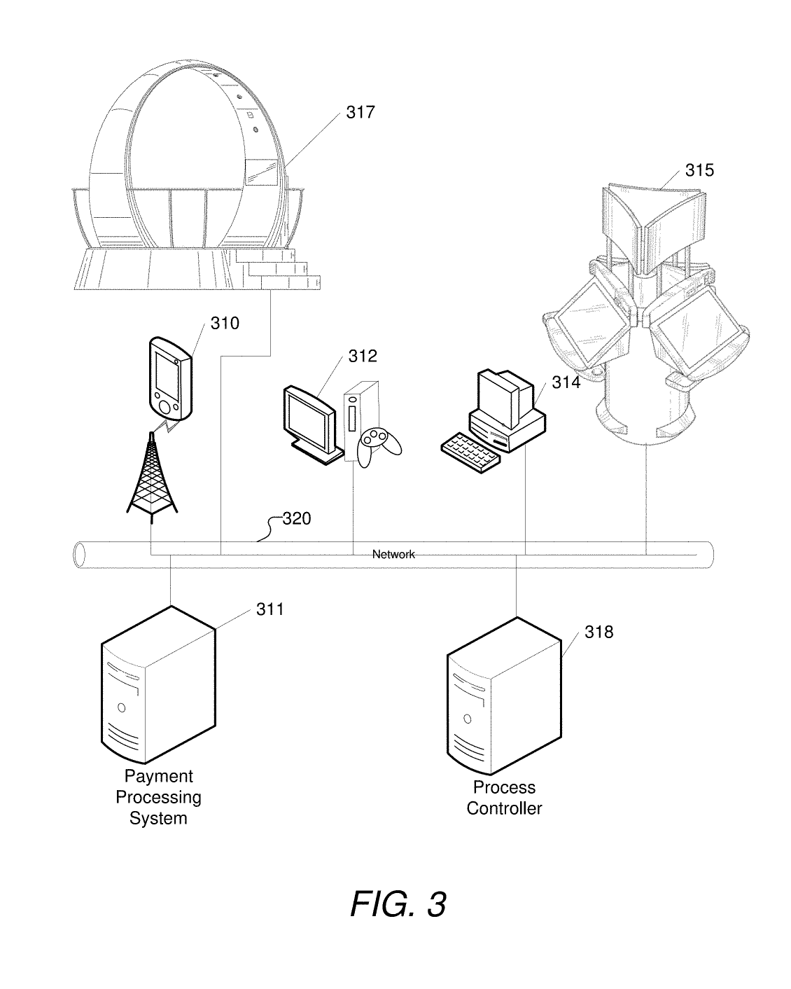

FIG. 3 is a diagram of distributed independent skill-wager element wagering systems in accordance with various embodiments of the invention. An interactive controller may be constructed from or configured using one or more processing devices that perform the operations of the interactive controller. An interactive controller in a distributed independent skill-wager element wagering system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface and/or through the use of an interactive application.

In some embodiments, an interactive controller may be constructed from or configured using an electronic gaming machine 315, such as a slot machine or the like. The electronic gaming machine 315 may be physically located in various types of gaming establishments.

In some embodiments, an interactive controller may be constructed from or configured using an virtual reality electronic gaming machine 317. The virtual reality electronic gaming machine 317 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete independent skill-wager element wagering system and may be operatively connected using a communication link to a session and/or management controller.

Some independent skill-wager element wagering systems in accordance with many embodiments of the invention can be distributed across a plurality of devices in various configurations. One or more interactive controllers of a distributed independent skill-wager element wagering system, such as but not limited to, a mobile or wireless device 310, a gaming console 312, a personal computer 314, an electronic gaming machine 315, and a virtual reality gaming machine are operatively connected with a process controller 318 of a distributed independent skill-wager element wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315 and a virtual reality gaming machine while one or more processes of a process controller as described herein can be executed by the process controller 318.

In many embodiments, a distributed independent skill-wager element wagering system and may be operatively connected using a communication link to a session controller (not shown), that performs the processes of a session controller as described herein.

In several embodiments, a distributed independent skill-wager element wagering system and may be operatively connected using a communication link to credit processing controller 311, that performs the processes of one or more credit processing controllers as described herein.

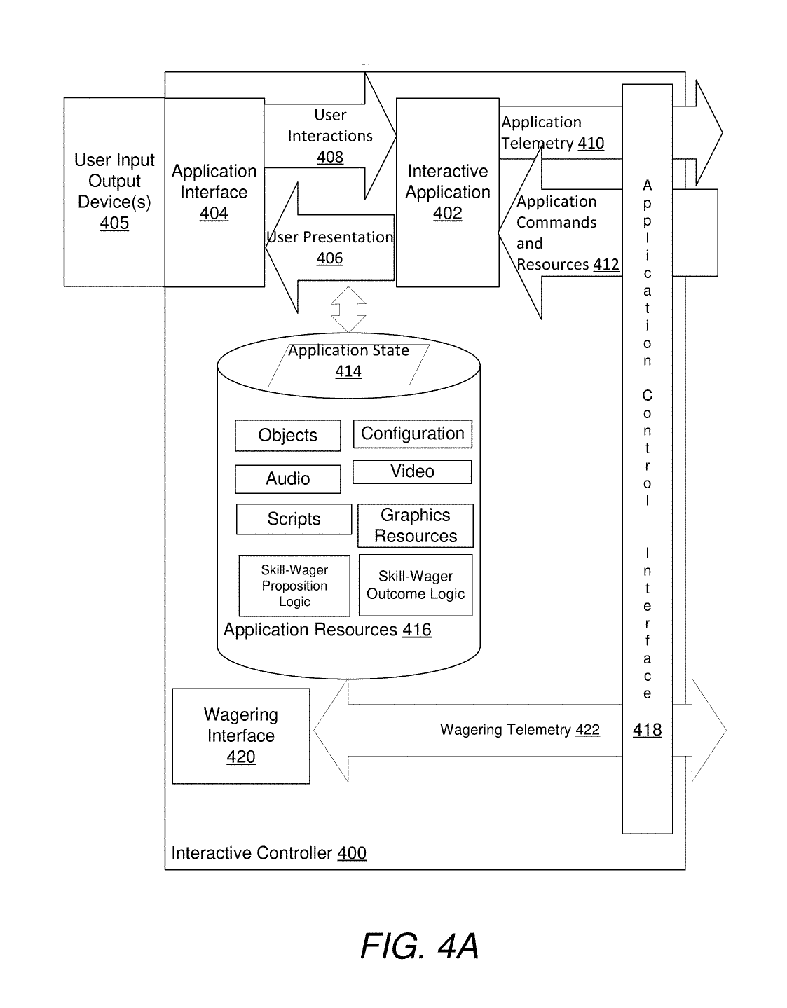

Referring now to FIG. 4A, an interactive controller 400, suitable for use as interactive controller 102 of FIG. 1, provides an execution environment for an interactive application 402 of an independent skill-wager element wagering system. In several embodiments, an interactive controller 400 of an independent skill-wager element wagering system provides an interactive application 402 that generates an application interface 404 for interaction with by a player. The interactive application 402 generates a player presentation 406 that is presented to the player through the application interface 404 using one or more player input and output devices 405. The player presentation 406 may include audio features, visual features or tactile features, or any combination of these features. In various embodiments, the application interface 404 utilizes one or more user interface input and output devices 405 so that a player can interact with the player presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of an independent skill-wager element wagering system as described herein. The interactive application 402 receives application commands and resources 412 communicated from various other components of an independent skill-wager element wagering system as described herein. In some embodiments, the application telemetry data 410 may include player interactions with objects of the interactive application and a skill-wager outcome for a skill-wager proposition presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the player presentation; audio files used to generate music, sound effects, etc. within the interactive application; configuration files used to configure the features of the interactive application; scripts or other types of control code used to provide various features of the interactive application; graphics resources such as textures, objects, etc. that are used by a graphics engine to render objects displayed in an interactive application; skill-wager proposition logic used to generate a skill-wager proposition for presentation to one or more players as described herein; and skill-wager outcome logic for determining a skill-wager outcome based on player interactions of one or more players as described herein.

In operation, components of the interactive application 402 read portions of the application state 414 and generate the player presentation 406 for the player that is presented to the player using the user interface 404. The player perceives the player presentation and provides player interactions 408 using the user input devices. The corresponding player interactions are received as player actions or inputs by various components of the interactive application 402. The interactive application 402 translates the player actions into interactions with the virtual objects of the application environment stored in the application state 414. Components of the interactive application use the player interactions with the virtual objects of the interactive application and the interactive application state 414 to update the application state 414 and update the player presentation 406 presented to the player. The process loops continuously while the player interacts with the interactive application of the independent skill-wager element wagering system.

The interactive controller 400 provides one or more interfaces 418 between the interactive controller 400 and other components of an independent skill-wager element wagering system, such as, but not limited to, a process controller. The interactive controller 400 and the other independent skill-wager element wagering system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as determined by the interactive application. The player interactions may also include resultant actions such as modifications to the application state 414 or game resources 416 resulting from the player's interactions taken in the independent skill-wager element wagering system interactive application. In some embodiments, player interactions include, but are not limited to, actions taken by entities such as non-player characters (NPCs) of the interactive application that act on behalf of or under the control of the player.

In various embodiments, the application commands and resources 412 include skill-wager proposition application commands and/or resources used by the interactive application to generate a presentation of a skill-wager proposition presented to a player and to determine a skill-wager outcome based on the player's skillful interaction with the presentation of the skill-wager proposition.

In some embodiments, the interactive controller 400 includes a wagering user interface 420 used to provide independent skill-wager element wagering system telemetry data 422 to and from the player. The independent skill-wager element wagering system telemetry data 422 from the independent skill-wager element wagering system includes, but is not limited to, data used by the player to configure credit, application credit and interactive element wagers, and data about the chance-based proposition credits, application credits and interactive element wagers such as, but not limited to, credit, application credit and interactive element balances and credit, application credit and interactive element amounts wagered.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the independent skill-wager element wagering system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a player when the player interacts with the interactive controller; physiological sensors that monitor the physiology of the player; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in an independent skill-wager element wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and independent skill-wager element wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of an independent skill-wager element wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of an independent skill-wager element wagering system includes an interactive application server operatively connected to an interactive client using a communication link. The interactive application server and interactive application client cooperate to provide the features of an interactive controller as described herein.

In various embodiments, the interactive controller 400 may be used to construct other components of an independent skill-wager element wagering system as described herein.

In some embodiments, components of an interactive controller and a process controller of an independent skill-wager element wagering system may be constructed from or configured using a single device using processes that communicate using an interprocess communication protocol. In other such embodiments, the components of an interactive controller and a process controller of an independent skill-wager element wagering system may communicate by passing messages, parameters or the like.

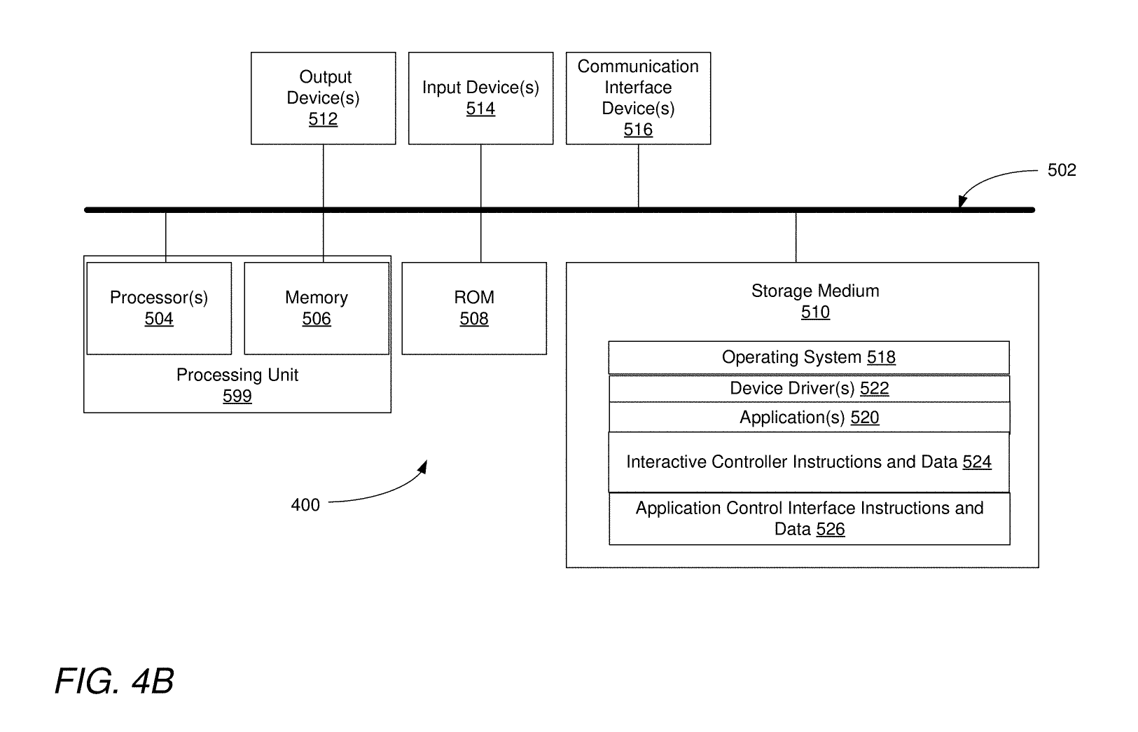

FIG. 5 is a diagram of a structure of a process controller, suitable for use as process controller 104 of FIG. 1, of an independent skill-wager element wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for one or more processors 663, random access memory (RAM) 664, read only memory (ROM) 665, machine-readable storage medium 666, one or more user output devices 667, one or more user input devices 668, and one or more communication interface and/or network interface devices 669.

The one or more processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the one or more processors 663 are operatively connected to audio output devices such as, but not limited to: speakers; and/or sound amplifiers. In accordance with many of these embodiments, the one or more processors 663 are operatively connected to tactile output devices like vibrators, and/or manipulators.

In the example embodiment, the one or more processors 663 and the random access memory (RAM) 664 form a process controller processing unit 670. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a player when the player interacts with the process controller 660.

The one or more communication interface and/or network interface devices 669 provide one or more wired or wireless interfaces for exchanging data and commands between the process controller 660 and other devices that may be included in an independent skill-wager element wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; one or more applications 672; one or more device drivers 673; and independent skill-wager element wagering system process controller instructions and data 674 for use by the one or more processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the one or more processors 663 via the bus 661, and then executed by the one or more processors 663. Data used by the one or more processors 663 are also stored in memory 664, and the one or more processors 663 access such data during execution of the machine-executable instructions. Execution of the machine-executable instructions causes the one or more processors 663 to control the process controller 660 to provide the features of an independent skill-wager element wagering system process controller as described herein.

Although the process controller 660 is described herein as being constructed from or configured using one or more processors and instructions stored and executed by hardware components, the process controller can be composed of only hardware components in accordance with other embodiments. In addition, although the storage medium 666 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the user input devices or user output devices may be operatively connected to the one or more processors 663 via one of the interfaces or using a communication link.

In various embodiments, the process controller 660 may be used to construct other components of an independent skill-wager element wagering system as described herein.

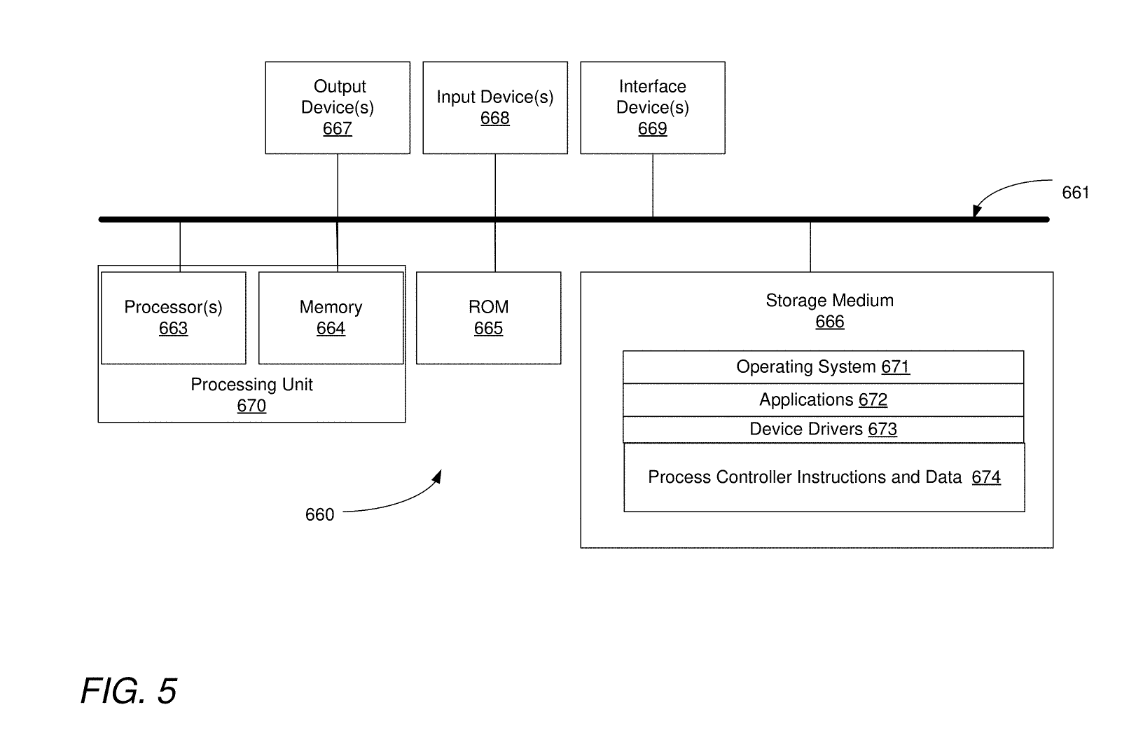

FIG. 6 is a diagram of a structure of a credit processing controller, suitable for use as credit processing controller 105 of FIG. 1, of an independent skill-wager element wagering system in accordance with various embodiments of the invention. A credit processing controller may be constructed from or configured using one or more processing devices that perform the operations of the credit processing controller. In many embodiments, a credit processing controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing controller 760 includes a bus 761 providing an interface for one or more processors 763, random access memory (RAM) 764, read only memory (ROM) 765, machine-readable storage medium 766, one or more user output devices 767, one or more user input devices 768, and one or more communication interface and/or network interface devices 769.

The one or more processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the one or more processors 763 are operatively connected to audio output devices such as, but not limited to: speakers; and/or sound amplifiers. In accordance with many of these embodiments, the one or more processors 763 are operatively connected to tactile output devices like vibrators, and/or manipulators.

In the example embodiment, the one or more processors 763 and the random access memory (RAM) 764 form a credit processing controller processing unit 770. In some embodiments, the credit processing controller processing unit includes one or more processors operatively connected to one or more of a RAM, ROM, and machine-readable storage medium; the one or more processors of the credit processing controller processing unit receive instructions stored by the one or more of a RAM, ROM, and machine-readable storage medium via a bus; and the one or more processors execute the received instructions. In some embodiments, the credit processing controller processing unit is an ASIC (Application-Specific Integrated Circuit). In some embodiments, the credit processing controller processing unit is a SoC (System-on-Chip).

Examples of user input devices 768 include, but are not limited to: tactile devices including but not limited to, keyboards, keypads, foot pads, touch screens, and/or trackballs; non-contact devices such as audio input devices; motion sensors and motion capture devices that the credit processing controller can use to receive inputs from a player when the player interacts with the credit processing controller 760.

The one or more communication interface and/or network interface devices 769 provide one or more wired or wireless interfaces for exchanging data and commands between the credit processing controller 760 and other devices that may be included in an independent skill-wager element wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the credit processing controller 760 such as, but not limited to: an operating system 771; one or more applications 772; one or more device drivers 773; and credit processing controller instructions and data 774 for use by the one or more processors 763 to provide the features of a credit processing controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the one or more processors 763 via the bus 761, and then executed by the one or more processors 763. Data used by the one or more processors 763 are also stored in memory 764, and the one or more processors 763 access such data during execution of the machine-executable instructions. Execution of the machine-executable instructions causes the one or more processors 763 to control the credit processing controller 760 to provide the features of an independent skill-wager element wagering system credit processing controller as described herein.

Although the credit processing controller 760 is described herein as being constructed from or configured using one or more processors and instructions stored and executed by hardware components, the credit processing controller can be composed of only hardware components in accordance with other embodiments. In addition, although the storage medium 766 is described as being operatively connected to the one or more processors through a bus, those skilled in the art of credit processing controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the user input devices or user output devices may be operatively connected to the one or more processors 763 via one of the interfaces or using a communication link.

In various embodiments, the credit processing controller 760 may be used to construct other components of an independent skill-wager element wagering system as described herein.

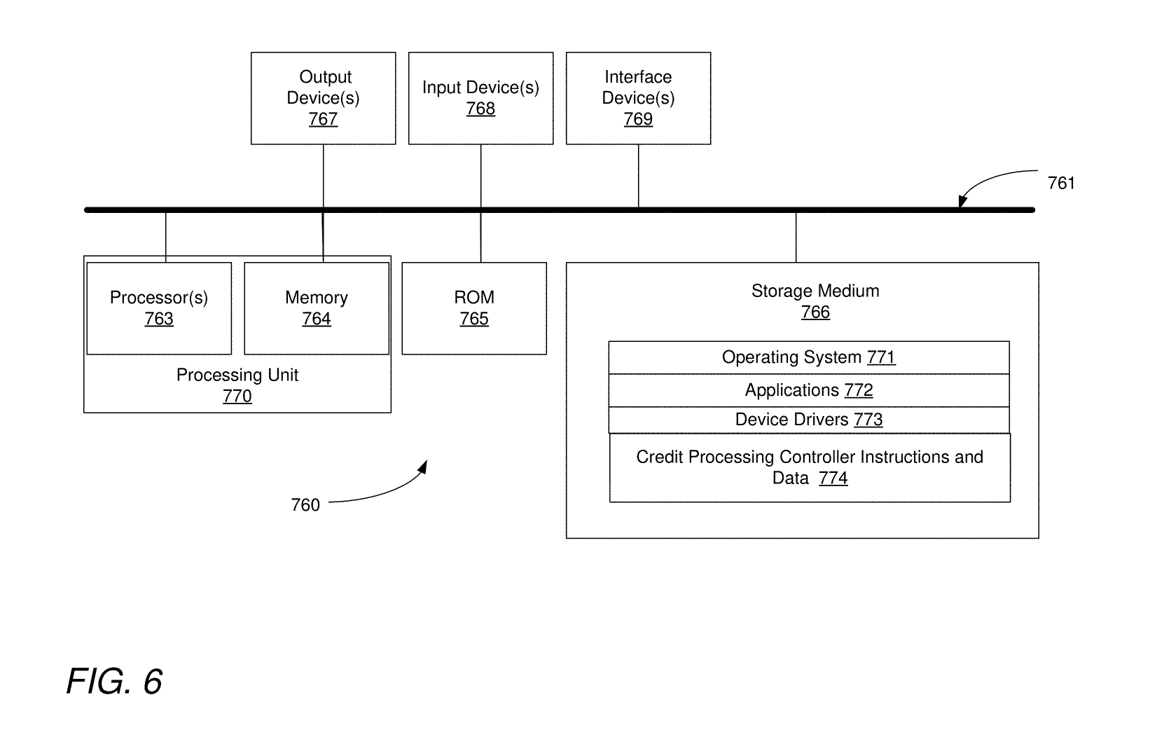

FIG. 7 is an illustration of a user interface 700 of an independent skill-wager element wagering system in accordance with various embodiments of the invention. In an example embodiment, an interactive application of an independent skill-wager element wagering system provides a skill-based game to a player in the form of a vehicle combat game. In playing the game, the player pilots a virtual vehicle 702 through a game world. While the player pilots the virtual vehicle, the player interacts with one or more interactive elements in the form of non-player characters piloting respective virtual vehicles controlled by artificial intelligence algorithms. The artificial intelligence algorithms utilize independent skill-wager elements that implement a skill-wager proposition independently of each other non-player character, that is, a skill-wager proposition resolved during the player's interaction with a non-player character will not be affected by the player's interactions with any other non-player characters. In some such embodiments, during skillful play by the player, the player overtakes a non-player character and interacts with the non-player character in the form of a virtual blow or strike in order to cause the non-player character to virtually crash the non-player character's virtual vehicle. Each virtual strike or blow from the player causes a commitment of an amount of credits as a wager and the player is awarded an amount of credits for each non-player character that the player causes to virtually crash. An artificial intelligence algorithm of the non-player character provides that the non-player character can block the virtual blow or strike administered by the player. An independent skill-wager element determines whether or not the non-player character blocks the virtual strike or blow based on one or more random components. If the non-player character blocks the virtual strike or blow, then the player will be unsuccessful in causing the non-player character to virtually crash.

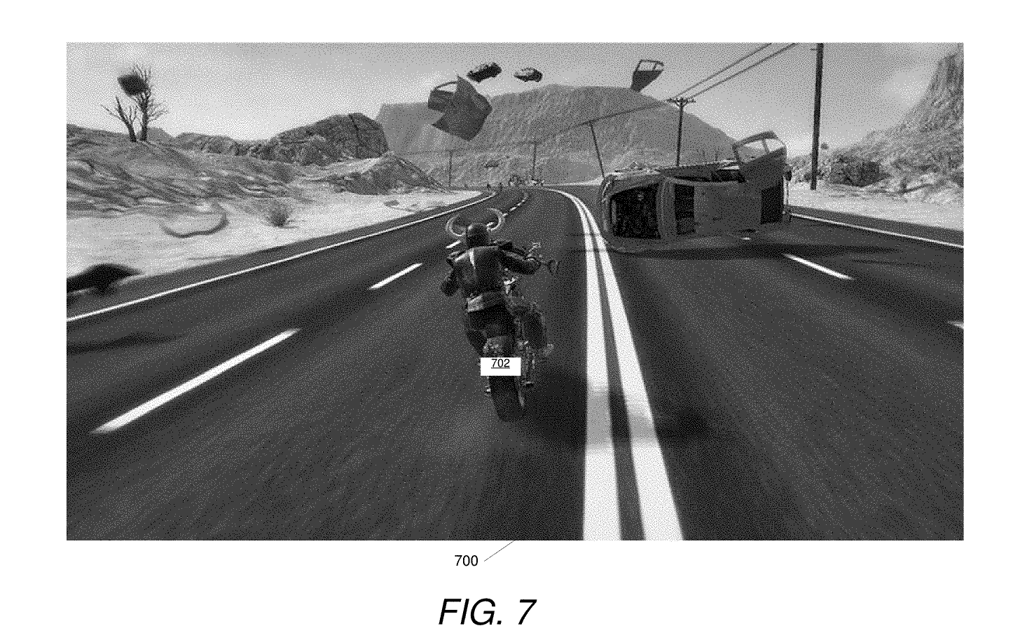

FIG. 8 is a block diagram of a process of an independent skill-wager element wagering system during a wagering session in accordance with various embodiments of the invention. An independent skill-wager element wagering system resolves 800 a skill-wager proposition by determining 802 one or more random components using one or more random results, generating 804 one or more independent skill-wager elements using the random components, and determining 806 a skill wager outcome using the one or more independent skill-wager elements and an additional one or more random components. In slightly more detail, one or more random components are used to generate 804 one or more independent skill-wager elements that will be used to shape a skill-wager proposition presented to one or more players. The skill-wager proposition is resolved 806 by determining a skill-wager outcome for the skill-wager proposition. During determination of the skill-wager outcome, the one or more independent skill-wager elements utilize one or more additional random components.

In some embodiments, as indicated by dashed line 808, a process controller of the independent skill-wager element wagering system performs processing for determining 802 the random components while an interactive controller performs processing for generating 804 the one or more independent skill-wager elements and determining 806 the skill-wager outcome.

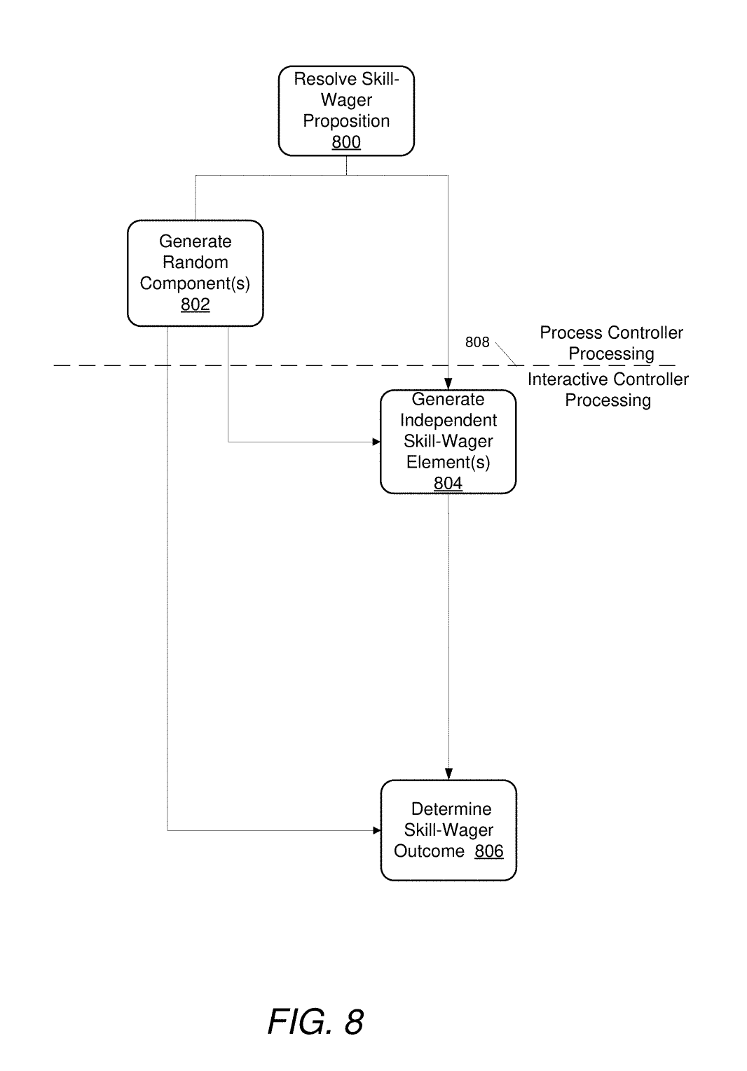

FIG. 9 is a sequence diagram of interactions between components of an independent skill-wager element wagering system during a wagering session in accordance with various embodiments of the invention. The components of the independent skill-wager element wagering system include a process controller 904, an interactive controller 906, and a credit processing controller 903.

In some embodiments, the process includes a credit input 909 to the independent skill-wager element wagering system as described herein. The credit processing controller 903 communicates data of the credit input 905 to the process controller 904 and the process controller 904 receives the incoming credit data 905. The process controller 904 uses the incoming credit data 905 to transfer 911 credits onto one or more player credit meters associated with one or more players of the independent skill-wager element wagering system, thus transferring credits into the independent skill-wager element wagering system and on to the one or more player credit meters.

The interactive controller 906 detects 907 one or more players performing a player interaction in an application interface of an interactive application provided by the interactive controller 906. The interactive controller 906 communicates application telemetry data 908 to the process controller 904. The application telemetry data 908 includes, but is not limited to, the player interaction detected by the interactive controller 906.

The process controller 904 receives the application telemetry data 908. Upon determination by the process controller 904 that the player interaction indicates initiation of a wagering session in accordance with one ore more skill-wager propositions, the process controller 904 determines 913 one or more random components and communicates data of the one or more random components 916 to the interactive controller. The interactive controller uses the one or more random components to generate 915 one or more independent skill-wager elements of a skill-wager proposition that is presented 918 to the one or more players. The presentation of the skill-wager proposition is presented to the one or more players in a user interface of the interactive application of the interactive controller 906. The presentation of the skill-wager proposition includes presenting to the one or more players through the user interface one or more interactive elements that utilize the one or more independent skill-wager elements. The one or more players interact with the one or more interactive elements while attempting to complete one or more skill objectives of the skill-based game. The interactive controller 906 detects 920 player interactions by the one or more players with the interactive elements utilizing the one or more independent skill-wager elements of the skill-wager proposition.

The interactive controller 906 communicates data of the player interactions as part of application telemetry data 922 to the process controller 904. The process controller 904 receives the application telemetry data 922 and in response determines 924 one or more random components based in part on the user interaction data included in the application telemetry data. The process controller updates 924 the one or more player credit meters and generates 924 wagering user interface updates reflecting the updated one or more player credit meters. The process controller communicates the one or more random components and data of the wager user interface updates as wagering telemetry data 926 to the interactive controller 906 and the interactive controller 906 receives the wagering telemetry data 926. The interactive controller 906 uses the wager user interface update data to update 928 a wagering user interface presented to the one or more players. The interactive controller 906 uses the random components and the player interactions with the one or more interactive elements having one or more independent skill-wager elements to determine 930 a skill-wager outcome based on the detected player interactions with the interactive elements of the skill-wager proposition, thus resolving a skill-wager proposition. The interactive controller 906 communicates data of the skill-wager outcome 924 to the process controller 904. The process controller 904 receives the skill-wager outcome data 932 and updates 934 the one or more player credit meters associated with the one or more players based on the skill-wager outcome data.

The process controller 904 generates 934 wagering telemetry data 936 using the data of the updated one or more credit meters. The process controller 904 communicates the wagering telemetry data 936 to the interactive controller 906. The interactive controller 906 receives the wagering telemetry data 936. The interactive controller 906 updates 938 a wagering user interface on a partial basis of the wagering telemetry data 936.

In many embodiments, upon determining that the wagering session is completed, such as by receiving a cashout communication from one or more players of the independent skill-wager element wagering system, the process controller 904 transfers credits off of the one or more player credit meters, generates outgoing credit data 940 on the basis of the credits transferred off of the one or more player credit meters, and communicates the outgoing credit data 940 to the credit processing controller 903. The credit processing controller receives the outgoing credit data 940 and generates 942 a credit output as described herein, thus transferring credits off of the one or more player credit meters and out of the independent skill-wager element wagering system.

In some embodiments, the process includes an application credit input to the independent skill-wager element wagering system with the process controller 904 communicating with the credit processing controller 903 to receive incoming application credit data. The process controller 902 uses the incoming application credit data to transfer application credits onto one or more application credit meters associated with one or more players of the independent skill-wager element wagering system, thus transferring application credits into the independent skill-wager element wagering system and on to the one or more application credit meters. The process controller 904 uses the skill-wager outcome data 924 to determine an amount of application credit to award to a player based on the player's skillful interactions with an interactive application executed by the interactive controller 905. Upon determining that the wagering session is completed, such as by receiving a cashout communication from one or more players of the independent skill-wager element wagering system, the process controller 904 transfers application credits off of the one or more application credit meters, generates outgoing application credit data on the basis of the application credits transferred off of the one or more application credit meters, and communicates the outgoing application credit data to the credit processing controller 903. The credit processing controller receives the outgoing application credit data and generates an application credit output as described herein, thus transferring application credits off of the one or more application credit meters and out of the independent skill-wager element wagering system.

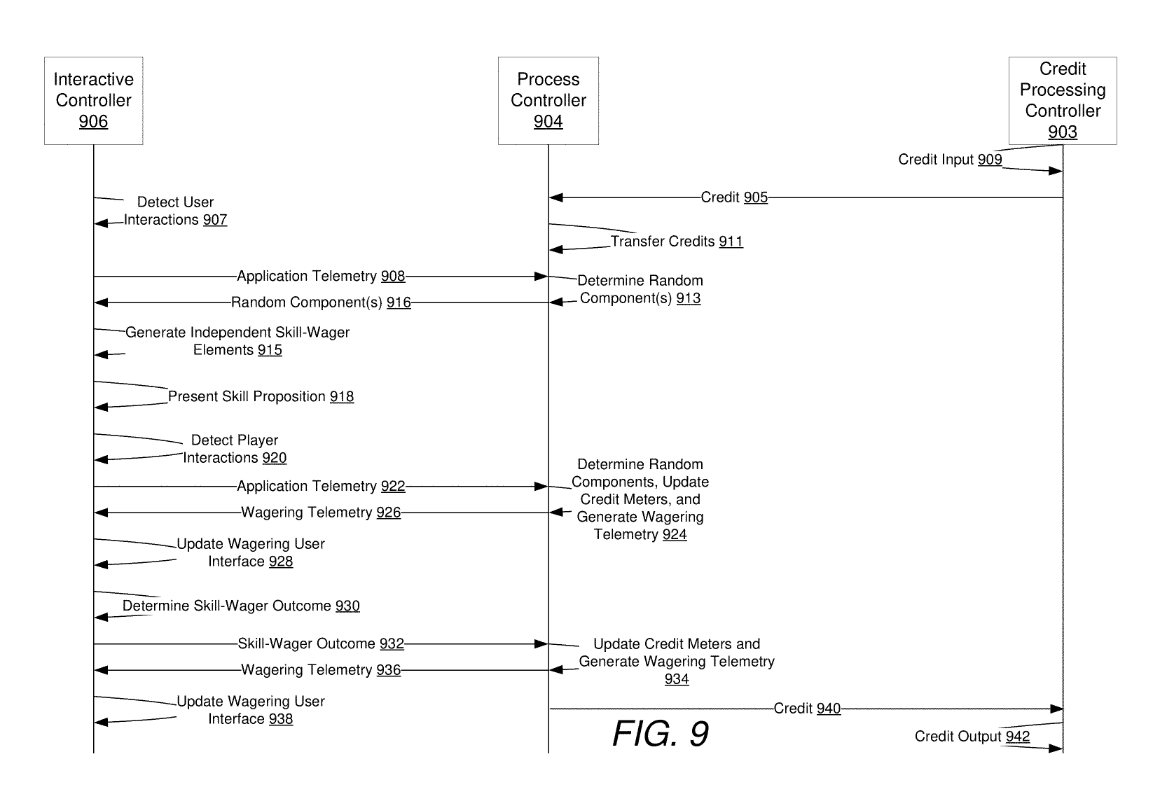

FIG. 10 is a state diagram illustrating a wagering process of an independent skill-wager element wagering system in accordance with various embodiments of the invention. The state diagram illustrates a process whereby one or more independent skill-wager elements associated with interactive elements of a skill-based game are selected on the basis of one or more random results of a random number generator. The interactive elements implement one or more skill objectives of the skill-based game. The one or more independent skill-wager elements compose a skill-wager proposition for presentation to a player within the skill-based game.

In the process, at an initial state S 1000, a process controller, such as process controller 104 of FIG. 1, uses one or more random number generators, such as random number generators 138 of FIG. 1, to generate one or more random results. The process controller uses the one or more random results to generate one or more random components that are communicated to an interactive controller, such as interactive controller 102 of FIG. 1. The interactive controller uses the one or more random components to generate one or more independent skill-wager elements for one or more interactive elements of a skill-based game being provided by the interactive controller. The one or more independent skill-wager elements are selected from a plurality of independent skill-wager elements each having one or more attributes that define one or more skill-wager propositions, as indicated by states ISWE₁ 1002 to ISWEₙ 1004 that are generated with respective probabilities of independent generation element P(IGE₁) 1006 to P(IGEₙ) 1008.

In an example embodiment, the random number generator generates random results and the process controller generates random components from the random results that have a uniform distribution, and the independent skill-wager elements are determined by selecting independent skill-wager elements from a look-up table mapping random components to independent skill-wager elements that will be utilized in an interactive element of the skill-based game. Each independent skill-wager element has an associated award having a fixed amount of credits that will be awarded to a player if the player achieves a skill-wager proposition represented by the interactive element that utilizes the independent skill-wager element. That is, the value of the award is not determined on the basis of the random result, but instead the skill-wager proposition is determined on the basis of the random result. The player must exhibit skillful play of the skill-based game to achieve the skill objective in order to earn the fixed award associated with the skill objective. That is, the player is not awarded the fixed award simply because the skill objective has been presented to the player; instead, the player achieves the skill objective in order to be awarded the fixed award.

During the player's skillful play of the skill-based game, the interactive elements including independent skill-wager elements comprising the skill objectives are presented to the player as described herein. The player interacts with the independent skill-wager elements attempting to achieve a skill objective associated with the independent skill-wager elements. If the player fails at achieving the skill objective, as indicated by P(Fi) 1010 through P(Fn) 1012, the wager process returns to the state where the player interacts with the independent skill-wager elements. That is, the player interacts with the independent skill-wager elements repeatedly until the player is able to achieve the skill objective represented by the independent skill-wager elements. If the player achieves the skill objective by successfully interacting with the interactive element having an independent skill-wager element, as indicated by P(Si) 1014 through P(Sn) 1016, then the player is awarded a fixed award associated with the independent skill-wager element, as indicated by states A₁ 1018 to Aₙ 1020. That is, the player may interact with the independent skill-wager elements repeatedly while the player attempts to achieve the skill objective. Each time the player interacts with the independent skill-wager elements, the system commits an amount of credits to a wager. As the outcome of the interaction is binary, that is the player either fails in the interaction and does not achieve the skill objective or the player does succeed in the interaction and achieves the skill objective in accordance with probabilities P(S₁) 1014 to P(Sₙ) 1020, the overall skill-wager proposition can be modeled as a wagering proposition where the probabilities of various outcomes can be modeled as a process having a geometric probability distribution.

The probability that a player will be presented with a particular independent skill-wager element is determined by the probability of a particular random component and the lookup table mapping a range of random results to that particular independent skill-wager element. The probability that a player will achieve a particular skill objective associated with the independent skill-wager element can be modeled as a process where the probability of success of the player is in accordance with a geometric probability distribution. Accordingly the, probability that the player will achieve a particular skill objective is a function of both the probability that the particular independent skill-wager element is selected by the interactive controller and the probability that the player can achieve the skill objective through skillful play of the skill-based game. Accordingly the expectation value of a player for a given skill objective and associated fixed award is given by:

E(Vᵢ)=P(ISWEᵢ)×P(Sᵢ)×Rᵢ, where:

E(Vᵢ)=Expectation value.

P(ISWᵢ)=Probability that the ith independent skill-wager element is selected.

P(Sᵢ)=Probability that player will achieve the ith skill objective.

Rᵢ=Value of the ith fixed award.

Additionally, the expectation value for the player of during skillful play of the skill-based game is given by:

E(V)==Σ₁₌₁^{N}E (Vi), where E(V) is the expectation value for the player.

FIG. 10 is a depiction of a non-player character configuration process in accordance with various embodiments of the invention. In some embodiments, a skill-based game provided by an interactive application executed by an interactive controller includes independent skill-wager elements that are opponents of a player in the form of non-player characters 1100. A player attempts to achieve a skill objective of defeating the non-player characters. The non-player characters are implemented using artificial intelligence attributes taken from an NPC template 1102 that are configurable based on a random component. One or more of the artificial intelligence attributes include one or more independent skill-wager elements 1104 as described herein. The artificial intelligence attributes provide for various behaviors of the non-player characters. When a non-player character is invoked in the skill-based game provided by an interactive application executing on an interactive controller, a random number generator 1106 is used to generate a random component. A set of configurations of the artificial intelligence attributes for the non-player character is determined by mapping through a mapping function 1108 portions of the range of the random result to one or more configurations of the artificial intelligence attributes. A fixed award 1110 of an amount of credits is associated with the non-player character based on the probability that the determined set of configurations of the artificial intelligence components is determined.

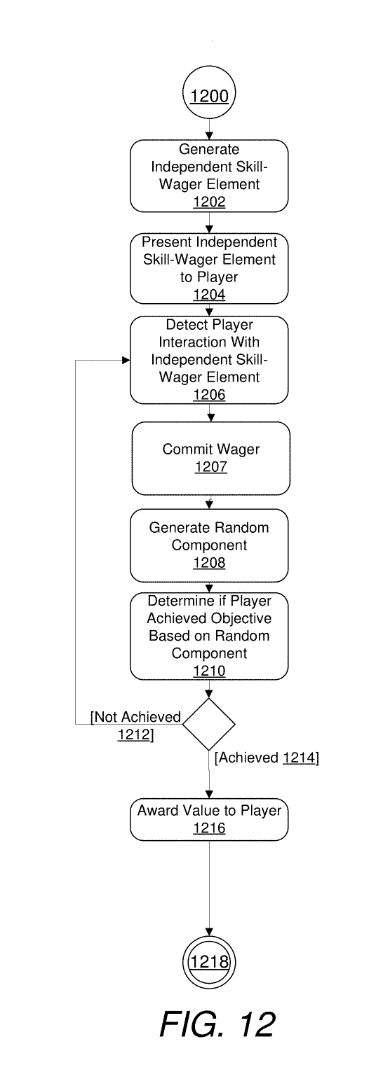

FIG. 12 is an activity diagram illustrating a process of an independent skill-wager element wagering system in accordance with various embodiments of the invention. At a start 1200 of the process, the system generates 1202 an interactive element in the form of an independent skill-wager element as described herein. The system presents 1204 the independent skill-wager element to a player. The system detects 1206 the player's interaction with the independent skill-wager element and commits 1207 an amount of credits to a wager. The system generates 1208 a random component in response to the detected interaction. The system determines 1210 if the player has successfully achieved an objective of successfully interacting with the independent skill-wager element based in part on the random component. If the system determines that the player has not achieved the objective 1212 the system continues to detect 1206 player interactions with the interactive element. If the system determines that the player has achieved the objective 1214, the system awards an amount of credits to the player.

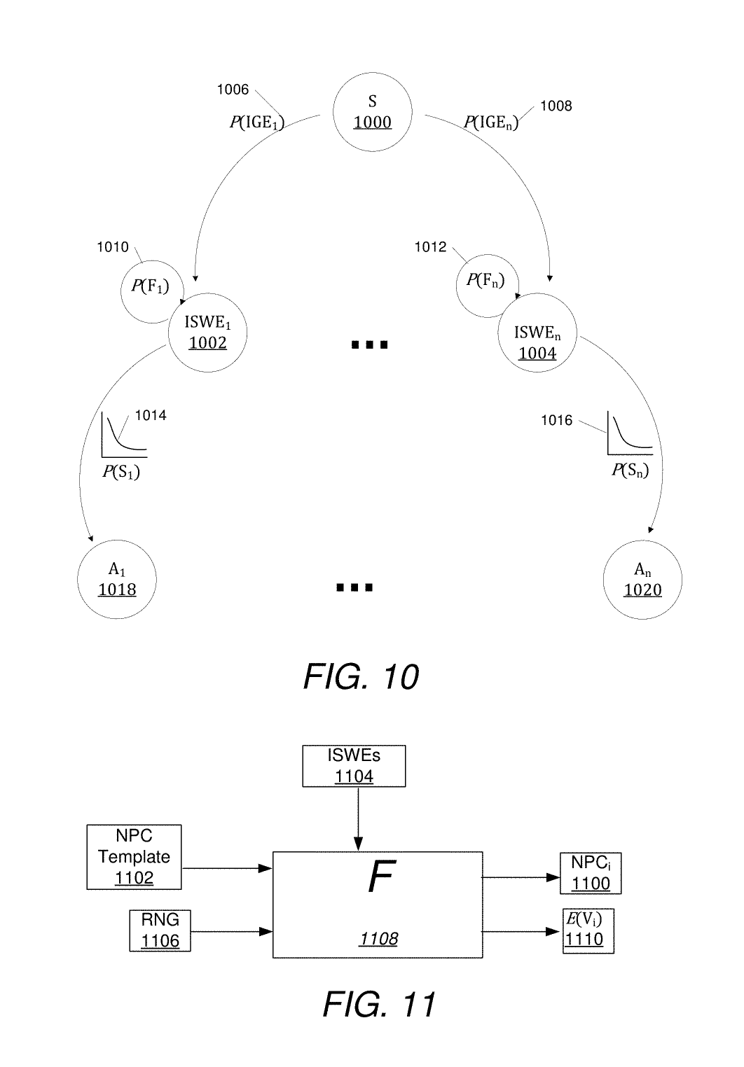

The wagering processes described in FIGS. 8, 9, 10, 11 and 12 may be combined in various ways to create wagering processes for various types of skill-based games.

In various embodiments, a player of a wager of an amount of credits is received from a player and the player is awarded a fixed award of an amount of credits for achieving one or more skill objectives associated with one or more independent skill-wager elements of a skill-wager proposition where a probability that the player will be able to achieve the one or more skill objectives is inversely proportional to the fixed award of an amount of credits such that the more difficult the one or more skill objectives are, the higher the fixed award of an amount of credits awarded to the player. The one or more skill objectives are randomly selected using a random component as described herein. The random result is mapped to various parameters and rule sets of skill objectives having varying difficulties to create a random component of the skill-wager proposition. Accordingly, the random result determines a difficulty of the one or more skill objectives but not the fixed award of an amount of credits awarded to the player for achieving the one or more skill objectives and it is up to the skill of the player to achieve the one or more skill objectives of the skill-wager proposition and be awarded the fixed award of an amount of credits associated with the one or more skill objectives.

In an example embodiment, an interactive application provides a skill-based puzzle piece drop game to a player, and the player is awarded with a fixed award of an amount of credits for achieving skill objectives of positioning dropped puzzle pieces composed of blocks to complete rows. Whether or not a next puzzle piece will allow the player to complete a row is determined by a random component of an independent skill-wager element. The puzzle piece is generated in a random orientation and a player attempts to rotate the puzzle piece by interacting with the puzzle piece. Each interaction results in a wager commitment and the success or failure of the interaction is determined by a random component. In some such embodiments, the player lines up puzzle pieces in various shapes to create a completely filled row. Each time the player creates a single row of blocks, the player is awarded a fixed award of an amount of credits. As each puzzle piece is generated, a random component determines whether or not the puzzle piece can be used to complete a row.

In another example embodiment, a skill-wager proposition is implemented in a first person shooter style skill-based game provided by an interactive application. The skill-based game has skill objectives in the form of non-player characters having artificial intelligence attributes include independent skill-wager elements as described herein. If a player achieves a skill objective by defeating a non-player character, the player is awarded a fixed award of an amount of credits where the player's probability of achieving the skill-objective is determined in part by a random component. The player continues to

In an example embodiment, a pinball-style video game is provided as a skill-based game by an interactive application executed by an interactive controller. The base skill objective of the skill-based game is to strike targets, sometimes referred to as toys, in a playing table of the pinball game using a pinball directed by the player using paddles or flippers. In some embodiments, interactive elements comprised of bumpers in front of the targets include one or more independent skill-wager elements. The bumpers may be active and prevent a pinball directed at a target from striking a target, and the bumpers may be inactive allowing a pinball directed at the target to strike the target. A random component of the one or more independent skill-wager elements determines whether or not the bumpers will become active or inactive.

In various embodiments, the one or more skill objectives are in the form of interactive elements that are one or more bumpers introduced into the playing table of the video pinball game such that the player must avoid striking the one or more bumpers in order to continue playing the pinball game. The bumpers are introduced into the player field in accordance with a random component of an independent skill-wager element as described herein. In some such embodiments, once one of the one or more bumpers are struck with a pinball, the player loses the pinball.

In another embodiment, a racing game is provided as a skill-based game of an interactive application of an interactive controller. A player wagers on the player's skill in overtaking non-player characters during a simulated race. During the simulated race, a player is presented with one or more skill-objectives of overtaking an opponent non-player character in the form of another racer. The characteristics of the non-player character are determined using a random component as described herein. Each attempt by the player to overtake a non-player character causes a commitment of an amount of credits as a wager. Whether or not the non-player character blocks the player from overtaking is determined by a random component of an independent skill-wager element associated with the non-player character.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An independent skill-wager element wagering system, comprising:
an interactive controller constructed to:
generate an independent skill-wager element of an interactive application;
present the independent skill-wager element to a player;
detect the player's interactions with the independent skill-wager element;
communicate the player's interactions to a process controller;
receive a random component from a process controller; and
determine that the player has achieved an objective associated with the interactive element on the basis of the random component; and
the process controller constructed to communicate with the interactive controller, wherein the process controller is constructed to:
receive the player's interactions from the interactive controller;
generate the random component in response to receiving the player's interactions; and
communicate the random component to the interactive controller.

2. The independent skill-wager element wagering system of claim 1, wherein the interactive controller and the process controller are constructed from the same device.

3. The independent skill-wager element wagering system of claim 1, wherein the process controller is operatively connected to the interactive controller using a communication link.

4. The independent skill-wager element wagering system of claim 1, further comprising:
an enclosure constructed to mount:
a user input device operatively connected to the interactive controller;
a user output device operatively connected to the interactive controller;
a credit input device operatively connected to the process controller; and
a credit output device operatively connected to the process controller.

5. The independent skill-wager element wagering system of claim 4, further comprising a random number generator, wherein the process controller is further constructed to:
communicate with the credit input device to receive a credit input;
credit a credit meter with credits based on the incoming credit data;
generate the random component using the random number generator;
receive a skill-wager outcome from the interactive controller;
update the credit meter based on skill-wager outcome of the wager; and
communicate with the credit output device to generate a credit output based on credits transferred off of the credit meter, and
wherein the interactive controller is further constructed to:
determine the skill-wager outcome based on the player's interactions with the independent skill-wager element and the random component; and
communicate the skill-wager outcome to the process controller.

6. An independent skill-wager element wagering system, comprising:
at least one processor; and
a memory coupled to the at least one processor, the memory storing processor-executable instructions that when executed by the at least one processor cause the at least one processor to:
generate an independent skill-wager element of an interactive application;
present the independent skill-wager element to a player;
detect the player's interactions with the independent skill-wager element;
generate the random component in response to receiving the player's interactions; and
determine that the player has achieved an objective associated with the interactive element on the basis of the random component.

7. The independent skill-wager element wagering system of claim 6, further comprising:
an enclosure constructed to mount:
a user input device operatively connected to the at least one processor;
a user output device operatively connected to the at least one processor;
a credit input device operatively connected to the at least one processor; and
a credit output device operatively connected to the at least one processor.

8. The independent skill-wager element wagering system of claim 7, further comprising a random number generator, wherein the processor-executable instructions further cause the at least one processor to:
communicate with the credit input device to receive a credit input;
credit a credit meter with credits based on the incoming credit data;
generate the random component using the random number generator;
determine the skill-wager outcome based on the player's interactions with the independent skill-wager element and the random component; and
update the credit meter based on skill-wager outcome of the wager.
